(19) United States
(12) Patent Application Publication
(10) Pub. No.: US 2020/0311600 A1
(43) Pub. Date: Oct. 1, 2020

(54) METHOD AND SYSTEM FOR PREDICTION OF APPLICATION BEHAVIOR

(71) Applicant: Dell Products L. P., Round Rock, TX (US)

(72) Inventors: Narayan Kulkarni, Bangalore (IN); Murali Krishna, Bangalore (IN); Syed Tanveer Ahmed, Bangalore (IN)

(21) Appl. No.: 16/369,858

(22) Filed: Mar. 29, 2019

(51) Int. Cl. G06N 20/00; G06F 8/71; G06N 5/02

(52) U.S. Cl. CPC G06N 20/00; G06N 5/02; G06F 8/71

(57) ABSTRACT

Methods, software programs, and systems for behavioral analysis of computer applications, and, more particularly, for the prediction of application behavior within and across heterogeneous environments, using machine learning techniques, are disclosed. A method according to certain of these embodiments includes retrieving merged configuration/utilization data and generating predicted application behavior information. The merged configuration/utilization data includes at least a portion of application configuration information and at least a portion of environment configuration information. The application configuration information is information regarding a configuration of an application. The environment configuration information is information regarding a configuration of an environment in which the application is executed. The predicted application behavior information is generated using a machine learning model, which receives the merged configuration/utilization data as one or more inputs.

The present disclosure relates to the development of software applications, and, more particularly, to methods and systems for the analysis of software application behavior, using machine learning techniques.

### BACKGROUND

Reductions in the cost of computing systems coupled with virtualization and large-scale utility computing have resulted in the widespread availability of computing resources and network connectivity. Coupled with the ever increasing number of mobile devices and various wireless networking technologies, the ubiquity of such computing resources has resulted in an ever increasing demand for all manner of software applications. This has, in turn, placed increased demands on the development of such software applications. Such a software development process can be divided into distinct phases, for example, in order to improve the design and product management of such software applications, as well as the project management involved in such software development. The methodology of such a software development process may include the pre-definition of specific deliverables and artifacts that are created and completed by a project team to develop or maintain a software application. The goal of such a software development process is the development and provision of reliable software functionality at an affordable price that meets the necessary performance requirements. As will be appreciated, with the demand for software applications continually increasing, there is a need for efficient, effective software application development techniques capable of satisfying the goals such as those mentioned above.

### SUMMARY

This Summary provides a simplified form of concepts that are further described below in the Detailed Description. This Summary is not intended to identify key or essential features and should therefore not be used for determining or limiting the scope of the claimed subject matter.

In various embodiments, disclosed are methods, software programs, and systems for behavioral analysis of computer applications, and, more particularly, for the prediction of application behavior within and across heterogeneous environments, using machine learning techniques. A method according to certain of these embodiments includes retrieving merged configuration/utilization data and generating predicted application behavior information. The merged configuration/utilization data includes at least a portion of application configuration information and at least a portion of environment configuration information. The application configuration information is information regarding a configuration of an application. The environment configuration information is information regarding a configuration of an environment in which the application is executed. The predicted application behavior information is generated using a machine learning model, which receives the merged configuration/utilization data as one or more inputs.

The foregoing is a summary and thus contains, by necessity, simplifications, generalizations and omission of detail; consequently those skilled in the art will appreciate that the summary is illustrative only and is not intended to be in any way limiting. Other aspects, inventive features, and advantages, as defined solely by the claims, will become apparent in the non-limiting detailed description set forth below.

### BRIEF DESCRIPTION OF THE DRAWINGS

Embodiments of methods and systems such as those disclosed herein may be better understood, and their numerous objects, features, and advantages made apparent to those skilled in the art by reference to the accompanying drawings. For ease of discussion, the same reference numbers in different figures may be used to indicate similar or identical items.

FIG. 1 is a simplified block diagram illustrating an example of an application environment path, in accordance with an embodiment of the present disclosure.

FIG. 2 is a simplified block diagram illustrating an example of application performance effects, in accordance with an embodiment of the present disclosure.

FIG. 3 is a simplified block diagram illustrating an example of a feature engineering architecture, in accordance with an embodiment of the present disclosure.

FIG. 4 is a simplified block diagram illustrating an example of a machine learning architecture, in accordance with an embodiment of the present disclosure.

FIG. 5 is a simplified diagram illustrating an example of an interaction ranking system for ranking component interactions based on weighted interactions, in accordance with an embodiment of the present disclosure.

FIG. 6 is a simplified diagram illustrating an example of a higher-order ranking system for ranking attributes, parameters, and interactions based on their impacts on application behavior, in accordance with an embodiment of the present disclosure.

FIG. 7 is a simplified block diagram illustrating an example of an application behavior prediction architecture, in accordance with an embodiment of the present disclosure.

FIG. 8 is a simplified block diagram illustrating an example of a configuration prediction architecture, in accordance with an embodiment of the present disclosure.

FIG. 9A is a simplified flow diagram illustrating an example of a machine learning process, in accordance with an embodiment of the present disclosure.

FIG. 9B is a simplified flow diagram illustrating an example of a prediction process, in accordance with an embodiment of the present disclosure.

FIG. 10 is a simplified flow diagram illustrating an example of a learning process, in accordance with an embodiment of the present disclosure.

FIG. 11 is a simplified flow diagram illustrating an example of a feature engineering process, in accordance with an embodiment of the present disclosure.

FIG. 12 is a simplified flow diagram illustrating an example of a configuration process, in accordance with an embodiment of the present disclosure.

FIG. 13 is a simplified flow diagram illustrating an example of an information merger process, in accordance with an embodiment of the present disclosure.

FIG. 14 is a simplified flow diagram illustrating an example of a machine learning model generation process, in accordance with an embodiment of the present disclosure.

FIG. 15 is a simplified flow diagram illustrating an example of a response time learning process, in accordance with an embodiment of the present disclosure.

FIG. 16 is a simplified flow diagram illustrating an example of a response time prediction process, in accordance with an embodiment of the present disclosure.

FIG. 17 is a block diagram depicting a computer system suitable for implementing aspects of an embodiment of the present disclosure.

FIG. 18 is a block diagram illustrating an example of an in-memory view of an implementation of systems according to an embodiment of the present disclosure.

FIG. 19 is a block diagram depicting a network architecture suitable for implementing aspects of an embodiment of the present disclosure.

While embodiments such as those presented in the application are susceptible to various modifications and alternative forms, specific embodiments are provided as examples in the drawings and description of example embodiments. It should be understood that the drawings and description of example embodiments are not intended to limit the embodiments to the particular form disclosed. Instead, the intention is to cover modifications, equivalents and alternatives falling within the spirit and scope of methods and systems such as those described herein, as defined by the appended claims.

### DETAILED DESCRIPTION

For purposes of this disclosure, an information handling system may include any instrumentality or aggregate of instrumentalities operable to compute, calculate, determine, classify, process, transmit, receive, retrieve, originate, switch, store, display, communicate, manifest, detect, record, reproduce, handle, or utilize any form of information, intelligence, or data for business, scientific, control, or other purposes. For example, an information handling system may be a personal computer (e.g., desktop or laptop), tablet computer, mobile device (e.g., personal digital assistant (PDA) or smart phone), server (e.g., blade server or rack server), a network storage device, or any other suitable device and may vary in size, shape, performance, functionality, and price. The information handling system may include random access memory (RAM), one or more processing resources such as a central processing unit (CPU) or hardware or software control logic, read-only memory (ROM), and/or other types of nonvolatile memory. Additional components of the information handling system may include one or more disk drives, one or more network ports for communicating with external devices as well as various input and output (I/O) devices, such as a keyboard, a mouse, touchscreen and/or video display. The information handling system may also include one or more buses operable to transmit communications between the various hardware components.

As used herein, the terms “consumer device,” “computing device,” or “mobile unit” may be used interchangeably to refer to a portable computing device with wireless communication capability. In particular embodiments, such a device may be the above-mentioned information handling system. In other embodiments, such a device may include any instrumentality or aggregate of instrumentalities operable to compute, determine, classify, process, transmit, receive, retrieve, originate, switch, store, display, communicate, manifest, detect, record, reproduce, handle, or utilize any form of information, intelligence, or data for personal, business, scientific, control, or other purposes. For example, as mentioned before, a consumer device or mobile unit may be a personal computer (e.g., a laptop), tablet computer, mobile device (e.g., personal digital assistant (PDA) or smart phone), or any other suitable device, and may vary in size, shape, performance, functionality, and price.

It is noted here that, for ease of discussion, a device or module may be referred to as “performing,” “accomplishing,” or “carrying out” a function or process. The unit may be implemented in hardware and/or software. However, as will be evident to one skilled in the art, such performance can be technically accomplished by one or more hardware processors, software, or other program code executed by the processor, as may be appropriate to the given implementation. The program execution could, in such implementations, thus cause the processor to perform the tasks or steps instructed by the software to accomplish the desired functionality or result. However, for the sake of convenience, in the discussion below, a processor or software component may be interchangeably considered as an “actor” performing the task or action described, without technically dissecting the underlying software execution mechanism. Furthermore, a hyphenated term (e.g., “technology-specific”, “computer-readable”, “Wi-Fi”, etc.) may be occasionally interchangeably used with its non-hyphenated version (e.g., “technology specific,” “computer readable”, “WiFi”, etc.), and a capitalized entry (e.g., “Device Manager”, “WiFi”, etc.) may be interchangeably used with its non-capitalized version (e.g., “device manager”, “wifi”, etc.). Such occasional interchangeable uses shall not be considered inconsistent with one another.

### Introduction

Methods and systems such as those described herein provide, for example, methods, apparatus, and systems that facilitate the development of software applications, and, more particularly, to methods and systems for the analysis of software application behavior, using machine learning techniques. Further, such behavioral analyses can facilitate the prediction of application behavior, and do so within a given environment, or across heterogeneous environments. Such systems can employ, for example, a computing device having a prediction engine that takes in configuration and utilization information, as well as load information (e.g., for application and non-application loads), and produces information regarding expected application behavior, as between an initial environment and a subsequent environment. Such results can be produced in terms of key performance indicators (KPIs) or other useful criteria, for example. Parameters that impact such an application's performance can include changes to application configurations, environmental configurations (of the initial and/or subsequent environments), application and non-application loads, and other such factors, as between such environments.

As noted, the creation of software is typically an iterative process. In certain software development processes, each of a number modules of an application is developed by coding portions thereof, and, once completed, performing unit testing on such completed modules. One or more iterations of such a process are typically performed. Once a number of such completed modules are completed and successfully tested, those modules can be integrated, and the integrated modules tested as a whole. Such coding, unit testing, integration, and integration testing can be performed to create a given software application, for example. Such operations are performed, for example, in a development and testing environment.

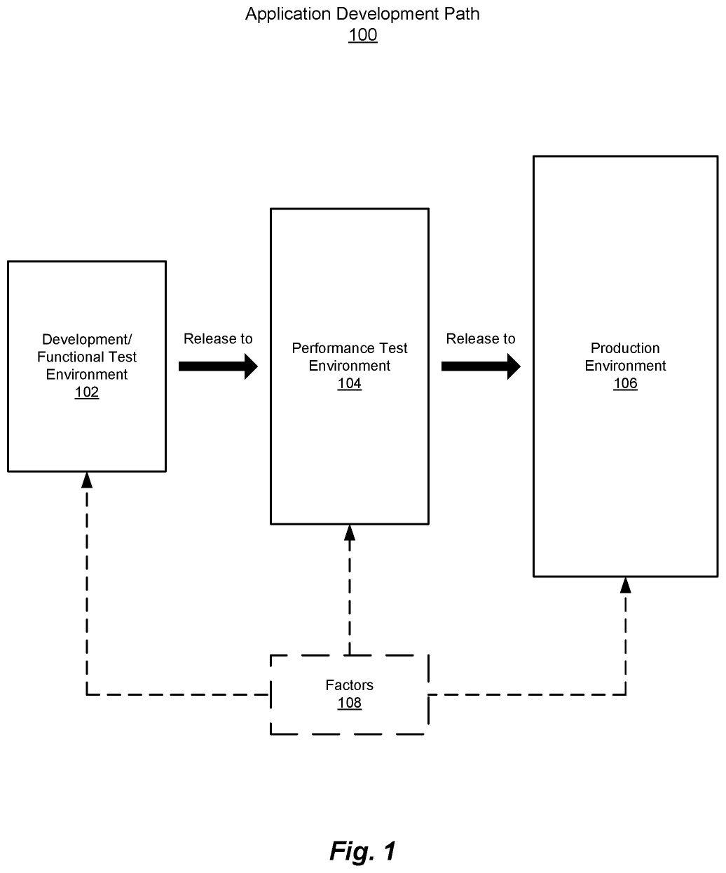

As will be appreciated in light of the present disclosure (and as is discussed in greater detail in connection with the description of FIG. 1), once an application is operational (e.g., a set of integrated modules that have been tested successfully), the application can be migrated to a performance testing environment. Such an application may (or may not) meet one or more performance testing criteria imposed on the application in the performance testing environment. If the application being performance tested does not meet such criteria, further development efforts may be needed, and so, in such situations, the application returns to the development/test environment for modification directed to configuring the application to meet the performance criteria in question. Alternatively, if the application meets the relevant performance testing criteria (which may include “tuning” of various application parameters in order for the application to meet such performance testing criteria), the application is ready to be released to a production environment (which, ultimately, will typically include release of the application to customers generally). That said, based on the application's ability to function in the production environment, the possibility exists that lack of performance or other flaws will come to light, and result in the need for further development, testing, and/or performance testing in the corresponding environment.

As will also be appreciated, various factors that impact an application's operation and performance will typically differ significantly, as between such environments. For example, an application in development (and so in a development/testing environment) will often execute with only a small number of other processes executing concurrently, in comparison to a performance environment or a production environment. The same can be said as between a performance environment and a production environment. In this regard, many organizations either do not or cannot provide a development/test environment that is as robust and complicated as a production environment. This can be the result of a number of factors, including the cost of replicating a production environment, the logistics involved, and other such considerations. This may be the case, for example, in situations in which it is not economically feasible for an organization to maintain a performance environment (or development/test environment) that is comparable to a production environment, due to the hardware resources available in and workloads (loads) supported by a production system. Further, the thrust of a development/test environment is the creation of an application, and so, simplicity and a focus on the application under development are needed. As a result, such a development/test environment is typically leaner and simpler than a production environment.

In view of the foregoing, predicting application behavior, particularly as between various of these environments using, for example, application performance monitoring tools and data capacity planning tools can prove cumbersome and error-prone, in part because such tools assume that an application is linearly scalable, and so, that its behavior changes in a linear fashion. Simplifying assumptions such as these are made, at least in part, as a result of the large number of variables potentially involved in such determinations. Further complicating such scenarios is the fact that such tools only account for changes in hardware. Application performance monitoring and data capacity planning tools also fail to provide for the comparison of application behavior in two or more environments, particularly with respect to the effects of configuration and utilization of software and hardware resources. Shortcomings such as these prevent the efficient and accurate prediction of application behavior, and so, whether various performance goals can be achieved and the parameters needed to do so.

Such tools also fail to examine custom application configuration parameters and non-application load parameters to determine application performance. For example, such tools fail to examine non-application load processes that drive non-application resource utilization in a given environment. Such effects can result from, for example, the use of shared resources in the environment (resources shared between processes executing in the environment) by processes not associated with the application. Such effects can result in unpredictable resource utilization and adversely impact application behavior. Application performance monitoring and data capacity planning tools are unable to account for such unpredictable conditions and their effects on system resources. Factors impacting application behavior can include, for example, configuration changes to existing hardware components, hardware upgrades, software and/or operating system (OS) patching, and/or other such factors.

In such cases, then, simply extrapolating performance testing results to a production environment scale would be neither easy, nor accurate. In such a scenario, a subject matter expert (SME) would need to analyze performance testing results and attempt to extrapolate the application's performance in the production environment based on the application's performance test results. However, such differences between environments result in constraints that make efficiently, effectively, and accurately predicting an application's behavior, from one environment to the next, problematic. Such an approach would not only be extremely labor-intensive, but would be inaccurate as a result of both the large number of variables and their interrelationships.

In view of the foregoing, methods and systems such as those described herein address such problems through implementations employing machine learning techniques that take into account factors affecting application behavior (e.g., configuration and utilization factors), even as between environments. In so doing, such methods and systems provide for the prediction of application behavior in, for example, a production environment, based on performance test results of an application in a performance testing environment and factors impacting application behavior in the production environment, with respect to various KPIs. A prediction engine according to such methods and systems is also able to predict application behavior within a given environment, using behavioral information from that and/or another environment, and parameters associated with those environments. Such a prediction engine can, for example, determine KPIs resulting from application configurations, application environment configurations, application loads, and non-application loads of such environments. By accounting for such factors, such a prediction engine can predict application behavior resulting from variations in the configuration and utilization of software and hardware resources across the heterogeneous environments.

In some implementations, analysis is performed using a computing device to determine application behavior in testing and production environments. Such a determination can include a prediction engine, one or more repositories, and associated computing, storage, and network resources. Such a prediction engine predicts performance metrics (e.g., application response times) as between one environment (e.g., a performance testing environment) and a subsequent environment (e.g. a production environment), in order to determine hardware and software configurations, and adjustments thereto, that may be needed to meet a given set of criteria (e.g., those set out in a service level agreements to be met by the application). Using application response time as an example, methods and systems such as those disclosed herein address aspects such as the following to overcome problems such as those described earlier:
Determining the expected response time of each of application module with respect to load (application+non application)
   methods with respect to web services
   pages with respect to web applications
   jobs/queries with respect to database applications
   messages with respect to messaging queues
   transactions with respect to integration tiers such as Enterprise Service Bus (ESB) components
   transactions with respect to load balancers and other related components of the ecosystem with relevant metric to measure on each of them
Determining the factor by which each of the performance impacting resources should be calculated in order to understand the application behavior in one environment versus the other
Derivation of the expected parameters, defining state of the application ecosystem, in order to achieve a target response time for a target application module (or set of modules).

For example, within a given environment, various relations can be defined based on characteristics of that environment. A first set of parameters that can be viewed as having an impact on an application's behavior can include, for example:
Application configurations—code base version, code complexity, heap size, custom application configurations, etc.
Application environment configurations
   Software configurations such as container configurations, cluster configurations, etc.
   Hardware configurations such as processor, memory, network, storage, etc.
   Other configurations such as OS parameters, version, limits, paging, etc.
Application Load—Application hits/calls/requests coming from various interlocked components along with self-calls
Non-application load—Maintenance processes, virus scans, online updates to the operating system, etc.

However, as will be appreciated, other sets of parameters exist, and can include parameters such as configuration parameters. Further, certain parameters that can be viewed as being related with both configuration and utilization during an application's execution. Examples of such a second set of parameters can include, for example:
Pure configuration parameters—processor make and model, hyper-threading, VM or physical machine, OS, OS patch version, etc.
Configuration as well as utilization parameters—number of application threads, memory utilization, process limits, page limits, etc.

A subset of the parameters that are included in both of the foregoing sets of parameters can be chosen as parameters of interest based on their impact on application behavior. The foregoing can be refined into the following definitions and relationships. Let:
N={Set of parameters from perspective North}
E={Set of parameters from perspective East}
C={Set of critical parameters}
O={Set of non-critical parameters}.

The relationship between N, E, C and O is

C⊆N∪E

and

O=(N∪E)−C

With respect to the first two sets of parameters, application behavior can be determined and understood from various standpoints, including, for example:
Application load versus application response time at each logical component
Non-application load versus application response time at each logical component
Application load versus resource utilization (software+hardware) at each logical component
Non-application load versus resources utilization (software+hardware) at each logical component
Critical parameters (application+non application) and their impact on the application response time
Non-critical parameters (application+non application) and their impact on the application response time
Impact of software parameters (application+non application) on response time
Impact of hardware parameters (application+non application) on response time
Combined impact of application load and non-application load on response time
Combined impact of software and hardware parameters on response time
Combined impact of critical and non-critical parameters on response time
Impact of each of the system changes (updates, upgrades, deployments, configuration changes) on response time
Predict/forecast application response time against every individual change and combination of changes that can happen in the application ecosystem
Predicting/forecasting the response time of application in production environment based on the performance environment application ecosystem behavior and production application ecosystem behavior and related predictions
Predicting anomalies in application response times using load (application+non-application) metrics

As can be seen from these examples, meaningful effects can result from both individual parameters, as well as interactions between groups of two or more parameters.

The advantages of methods and systems such as those described herein include the ability to account for custom application configuration parameters, non-application load parameters, system changes (both hardware and software), and other such factors. This results in a significant improvement in the accuracy with which an application's behavior, particularly as between environments, can be predicted, and the efficiency with which such predictions can be generated. Further, the use of machine learning techniques addresses problems associated with the large number of parameters encountered in such settings. Such advantages not only provide for a faster and more efficient process of creating software applications, but result in more efficient applications that make more efficient use of system resources.

### Examples of Machine Learning and Prediction Architectures

FIG. 1 is a simplified block diagram illustrating an example of an application environment path, in accordance with an embodiment of the present disclosure. FIG. 1 thus depicts an application development path 100, which is an example of the environments in which a given application might be executed as part of the application's development, integration, test, and release. In the example presented in FIG. 1, application development path 100 includes a development/functional test environment 102, a performance test environment 104, and a production environment 106. As noted, the aforementioned environments are merely examples, and can be supplemented, divided, and/or combined, for example, depending on the particular implementation. Thus, for example, development/functional test environment 102 could be separated into a development environment and a functional test environment, with one or more application modules being developed into a functional state, tested as a module, and then subjected to integration and testing in the functional test environment. Further, while the aforementioned environments are described with regard to specific phases of application development, integration, test, and release, methods and systems such as those described herein can also be applied in any scenario in which it is advantageous to predict one or more aspects of an application's behavior in one environment, based on that application's behavior (or that of another application) in another environment.

In the example presented in FIG. 1, development of an application begins with development and test of the application in development/functional test environment 102. In the example, once the application has been sufficiently developed, and has passed whatever functional testing is to be performed, the application is released from development/functional test environment 102, two performance testing environment 104, and so proceeds along application development path 100. Similarly, once the application has met performance criteria of performance test environment 104, the application is released to a production environment such as production environment 106.

Affecting the application's behavior in each of these environments are one or more variables, components, and/or parameters (e.g., depicted in FIG. 1 as factors 108, which can, for example, include application and/or environmental attributes). Examples of several such factors are listed below in Table 1.

TABLE 1
Examples of factors having potential
effects on application behavior.

| Factor | Examples |
|---|---|
| Application | Code base version, code complexity, |
| configurations | heap size, custom application configurations |
| Application | Software configurations (including, e.g., container |
| environment | configurations, cluster configurations, and the like) |
| configurations | Hardware configurations (e.g., processor type and |
| | speed, memory amount and speed, available network |
| | bandwidth, storage amount and speed, and the like) |
| Application | Application hits/calls/requests coming from various |
| load | interlocked components, as well as application |
| | self-calls |
| Non-application | Maintenance processes, virus scans, online OS updates |
| load | |

As is shown in Table 1, factors 108 can include variables, components, and parameters, among other such factors, as may affect an application's behavior in transitioning from one environment to another. Key performance indicators (KPIs) can be determined as between multiple heterogeneous environments, such as development/functional test environment 102, performance test environment 104, and production environment 106.

The variables, components, and parameters are associated with the KPIs that are determined as between the initial and subsequent environments. Various KPIs correspond to tests results that are associated with the heterogeneous environments in question. The relationship between test results and associated KPIs as between development/functional test environment 102 and performance test environment 104 can be based on, for example:

Perf test performance KPI1=t1*Dev/Functional test performance KPI1;

Perf test performance KPI1=t2*Dev/Functional test performance KPI2;

Perf test performance KPI1=tn*Dev/Functional test performance KPIn.

The relationship between test results and associated KPIs as between performance test environment 104 and production environment 106 can be based on, for example:

Production performance KPI1=a1*Perf test performance KPI1;

Production performance KPI2=a2*Perf test performance KPI2;

Production performance KPIn=an*Perf test performance KPIn.

KPIs can be based on, for example, the factors noted (e.g., application configurations, application environment configurations, application loads, and non-application loads). Such KPIs can also be based on changes to such configurations and loads. Such application configurations can include attributes/parameters (or associated changes thereto) of one application, or multiple applications (and/or multiple instances thereof).

Application environment configurations can include software configurations, container configurations (for containerized applications), cluster configurations, and so on. The software configurations can include the Operating System (OS) employed, the OS's version, a quantity of potential users, or the like. Application environment configurations can also include hardware configurations, such as CPU model, CPU characteristics, memory characteristics, network characteristics, storage characteristics, and other such hardware characteristics.

Application load can include tunable application performance characteristics, system calls, storage system requests, and the like, and can include the load placed on the application by inputs to/processing by the application (e.g., application load will typically increase in response to an increase in the number and/or frequency of inputs to the application). Application load can also include system load (the load on the given system created by the application's execution). Application load can be measured in terms of actual load on the system that is created by the application (e.g., system resources consumed by the application) and/or the load on the application caused by inputs/processing by the application, at a given point in time. Such loads can, alternatively (or in combination), represent loads on the application/system over a given time period (e.g., as by averaging such loads over a set period of time).

Non-application loads can include unexpected changes to the computing system, utility programs, system and/or user daemons, and/or other loads (other than the application in question). Such non-application loads can include deployment of one or more other applications (unrelated to the application in question), maintenance processes, online updates to the operating system, management systems, and other processes that consume software/hardware resources within the environment. Such processes can include on or more virtual machines (VMs), applications running on those VMs (other than the application in question), supporting systems (e.g., a hypervisor), and the like.

The application configuration and application environment configuration are typically static, having been configured prior to execution of the application in the given environment. For example, an administrator can manually configure the number of application threads allowed to execute concurrently. The application load and non-application load can be dynamic, such as the simulation of a first number of users during a first time period, followed by a change to a second (different) number of users during a second time.

The application configurations, the application environment configurations, the application load, and the non-application load can be factors that determine the performance of the application in the given environment. Such factors can impact parameters related to system resources. Such system resources can include software resource utilization and hardware resource utilization. Software resource utilization can include the number of threads dedicated for use by the application, the number of users simulated (or using an application in a production environment), the number of network connections (e.g., ports) allowed, and/or the like. Hardware resource utilization can include CPU utilization, memory utilization, network utilization, and so on. Software resource utilization and hardware resource utilization are, in certain embodiments, dynamic, and can vary based on the factors driving such utilization (e.g., factors such as those noted in Table 1). Software resource utilization and hardware resource utilization are, in certain embodiments, the impacted parameters, which can, in turn, affect the application behavior, such as the application response time.

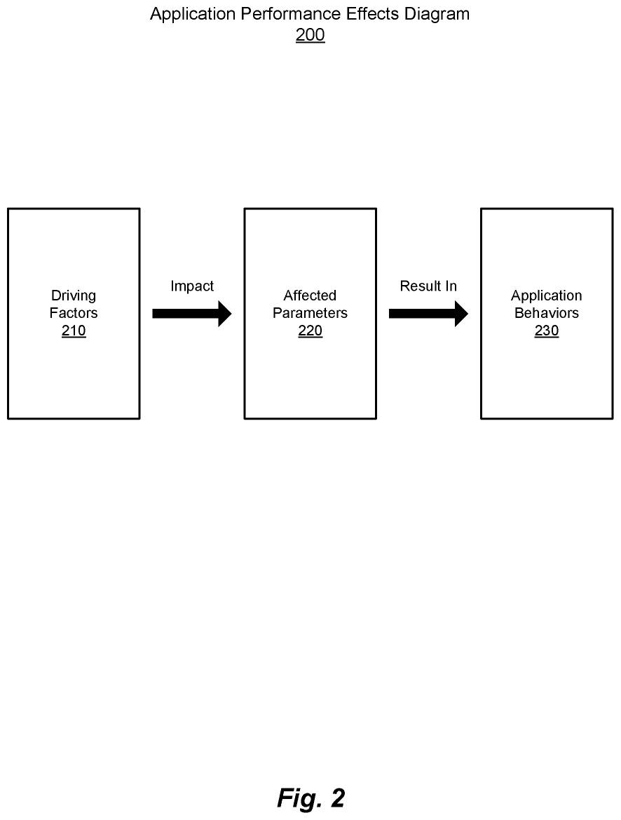

FIG. 2 is a simplified block diagram illustrating an example of application performance effects, in accordance with an embodiment of the present disclosure. That being the case, FIG. 2 depicts an application performance effects diagram 200, which illustrates an example of the cause/effect relationships between various environmental attributes and configured application parameters, and the effects such attributes and parameters can have on application behavior. Application performance effects diagram 200 thus depicts some number of driving factors 210, and their impact on one or more affected parameters 220. As is also depicted, the impact of driving factors 210 on affected parameters 220, alone or in combination, result in one or more application behaviors 230. Using methods and systems such as those described herein, one can determine changes in one or more of application behaviors 230 caused by changing one or more of driving factors 210 and/or the impact such factors may have on affected parameters 220.

Driving factors 210 can include factors such as application configurations and application environment configurations, which can be viewed as constant factors when determining application behavior (e.g., performance), as such factors will typically not change during an application's execution. Driving factors 210 can also include the application loads and the non-application loads to which the system is subjected. These factors can be viewed as dynamic (i.e., variable) factors when determining application behavior (e.g., performance), as such factors may change during an application's execution. In turn, such application and environment configurations (which are typically constant, as noted), and such application and non-application loads (which can change, as noted) drive affected parameters 220. Affected parameters 220 include parameters such as software resource utilization and hardware resource utilization. As such, affected parameters 220 can also be viewed as being variable because, in similar fashion, affected parameters 220 may change during an application's execution. Factors such as software and hardware resource utilization, in turn, drive (result in) the behavior of the given application (depicted in FIG. 2 as application behaviors 230 (e.g., application response times), which can also be considered as variable, being based on other factors subject to variability).

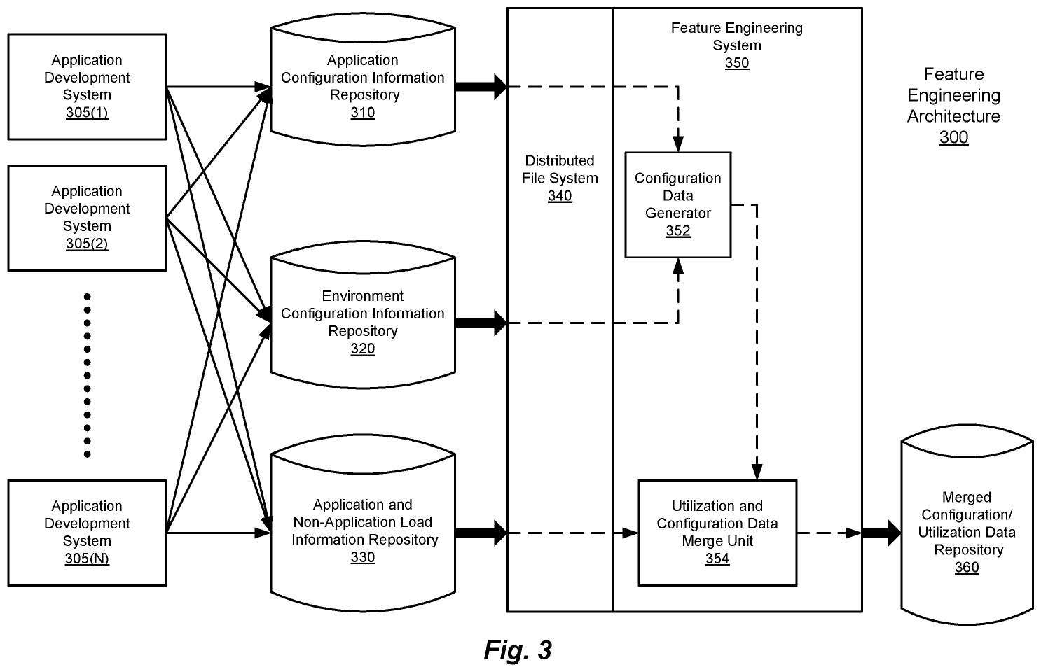

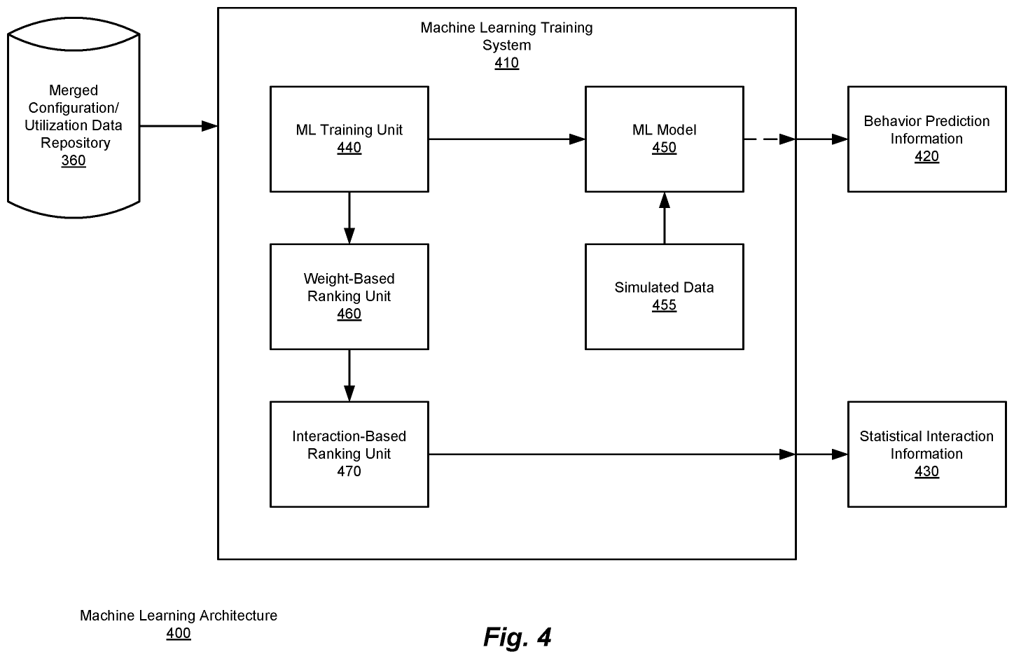

FIG. 3 is a simplified block diagram illustrating an example of a feature engineering architecture, in accordance with an embodiment of the present disclosure. FIG. 3 thus illustrates a feature engineering architecture 300 that aggregates information regarding application and environment configuration information, and aggregates this information for use by a machine learning system such as that subsequently described in connection with FIGS. 4-8. Feature engineering architecture 300 includes a number of application development systems (e.g., depicted in FIG. 3 application development systems 305(1)-(N), and referred to collectively as application development systems 305), which can be used to develop and test one or more software applications, for example. As such, a set of systems such as application development systems 305 can provide support for development/functional testing (and so, a development/functional testing environment), performance testing (and so, a performance testing environment), and production testing (and so, a production environment).

Application development systems 305 collect information regarding configuration of the application(s) under development (referred to herein as application configuration information) and configuration of the environment in which such application(s) is (are) executed (referred to herein as environment configuration information) for the testing functionality and environments supported thereby. Such information, once collected, is stored, respectively, in an application configuration information repository 310 and an environment configuration information repository 320. As noted, such application configuration parameters include the code base version, the code complexity, the heap size, the custom applications, and other such parameters and information. As also noted, an application environment configuration database such as that depicted can store application environment configuration parameters associated with the application in question. Environment configuration information can include parameters such as software configurations (such as container configurations, cluster configurations, and the like) and hardware configurations (such as processor type and speed, memory size, network bandwidth, available storage, and the like).

Application development systems 305 also collect load information for such application(s), as well as load information for other software executing in the given environment (referred to herein as non-application load information, reflecting the computational and/or storage resources consumed in the support of such other processes). Such an application load and non-application load database stores the application load parameters and the non-application load parameters that are associated with the applications in question. Such application load parameters can include application hits/calls/requests and self-calls, while such non-application load parameters can include maintenance processes, OS utility processes, and OS and storage management processes. Such utilization information, once collected, is stored in an application and non-application load information repository 330.

Supporting the storage of such information (e.g., application configuration information repository 310, environment configuration information repository 320, and application and non-application information repository 330) is a distributed file system 340. Distributed file system 340 interfaces with a feature engineering system 350 to provide such information thereto, for subsequent generation and merging of such information, as is described subsequently. In so doing, distributed file system 340 provides application configuration information (from application configuration information repository 310) and environment configuration information (from environment configuration information repository 322) to a configuration data generator 352 of feature engineering system 350. Configuration data generator 352 combines application configuration data and application environment configurations data to generate the layer-wise software and hardware configuration datasets. In turn, application and non-application load information from application and non-application load information repository 330 and the configuration data generated by configuration data generator 352 are provided to a utilization and configuration data merge unit 354. Utilization and configuration data merge unit 354 merges the configuration data, and the application and non-application load information, and provides this merged information for storage in a merged configuration/utilization data repository 360. Such merging can be based, for example, on time stamps associated with utilization data, as well as layer-wise software and hardware configuration data, which can then be used by a machine learning architecture in predicting application behavior as between environments.

FIG. 4 is a simplified block diagram illustrating an example of a machine learning architecture, in accordance with an embodiment of the present disclosure. FIG. 4 thus illustrates a machine learning architecture 400, which includes merged configuration/utilization data repository 360 (comparable to that depicted in FIG. 3) coupled to a machine learning training system 410. Machine learning training system 410 retrieves merged configuration/utilization data (e.g., with respect to the initial environment) from merged configuration/utilization data repository 360 and, in turn, generates behavior prediction information 420 and statistical interaction information 430.

In order to generate behavior prediction information 420 and statistical interaction information 430, machine learning training system 410 includes a machine learning (ML) training unit (depicted in FIG. 4 as an ML training unit 440), which is communicatively coupled to a machine learning model (depicted in FIG. 4 as an ML model 450) that also can take as input simulated data 455. In one implementation, ML training unit 440 is implemented using a multi-layer perceptron (MLP) architecture that employs regularization. As such, ML training unit 440 can be a feedforward artificial neural network model that maps large sets of input data onto a set of appropriate outputs. ML training unit 440 can include multiple layers of nodes in a directed graph, with each layer fully connected to the next. Except for the input nodes, each node acts as a neuron (or processing element) with a nonlinear activation function. As will be further appreciated, MLP techniques can provide salutary effects in the methods and systems such as those described herein due at least in part to the ability of such techniques to solve problems stochastically, which is able to allow approximate solutions for extremely complex problems such as fitness approximations of the factors described herein. Such MLP techniques are well-suited to situations such as those considered herein, at least as a result of the large number of parameters involved in each of the possible factors affecting application behavior in these various circumstances, particularly when interactions between such parameters are considered. That being the case, such solutions can facilitate not only improvements in the application's behavior, but also in the efficiency and overall accuracy of the process by which such solutions are reached.

ML training unit 440 receives merged configuration/utilization data from merged configuration/utilization data repository 360. Such merged configuration/utilization data can include attributes, KPIs, and parameters impacting application behavior within the heterogeneous environments. ML training unit 440 determines the impact of such factors on application behavior with respect to each of the heterogeneous environments, and maps such attributes, parameters, and other factors affecting application behavior as data sets, onto corresponding output sets. Such output sets can include individual parameters, attributes, and other factors that can impact application behavior, as well as combinations of factors impacting application behavior (e.g., with respect to a subsequent environment, a differently-configured initial environment, or the like).

ML training unit 440 generates a machine learning model (depicted in FIG. 4 as an ML model 450), and so is communicatively coupled thereto. ML training unit can perform such generation by mapping the aforementioned output sets into ML model 450 as an MLP model. In so doing, such mapping of the output sets into the MLP model is dynamic and automatic, and so can be accomplished without SME intervention.

That being said, ML model 450 can also take simulated data 455 as input. ML model 450 can thus include data that is based on SME-provided data (e.g., simulated data), as part of the training operations performed. An SME may also set one or more constraints, such as a fixed application response time for training to determine one or more values for the parameters to meet an application's behavioral goals. An SME might, for example, manually limit an application response time to three seconds. ML training unit 440 can then vary one or more application configuration parameters, application environment configuration parameters, and/or application load and/or non-application load parameters to reach the three-second application response time.

ML model 450 can thus map output sets to generate an MLP model. ML model 450 will typically include multiple layers of nodes in a directed graph or graphs, with each layer fully connected to the next. This neural network can be used to identify predicted application behaviors (e.g., application response times), and can account not only for the given set of parameters, but also the interactions between such parameters. For example, such a model can be used to determine and application's response time within a production environment based on parameters and/or changes to parameters within the performance test environment and/or parameters and/or changes to parameters within the development/functional test environment. ML model 450, having interacted with ML training unit 440 and received simulated data 455, can be used to produce behavior prediction information 420. As will be appreciated in light of the present disclosure, a determination can be made as to whether behavior prediction information 420 is sufficiently accurate (e.g., application behavior that is predicted reflects actual application behavior with sufficient accuracy). In this manner, a feedback loop of sorts is effected, wherein ML model 450 can be adjusted based on the accuracy of behavior prediction information 420, in order to arrive at a machine learning model that provides the requisite accuracy in its output.

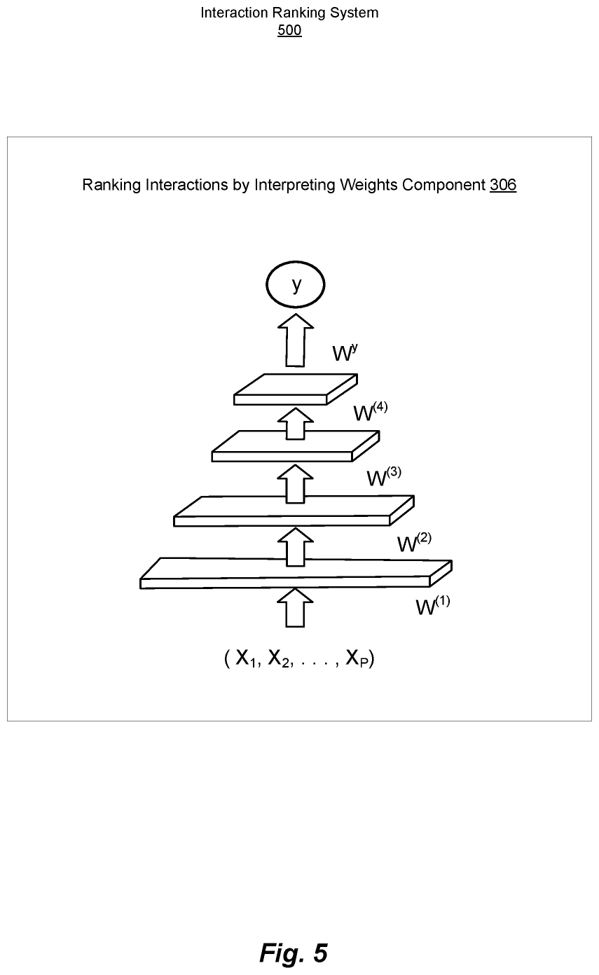

ML training unit 440 also provides information to a weight-based ranking unit 460, which uses this information to generate weighting information. Such weight-based ranking is described in further detail in connection with FIG. 5, subsequently. ML training unit 440 communicates information, such as the impacts on application behavior that have been determined, to weight-based ranking unit 460. Weight-based ranking unit 460 assigns a weight to each parameter based on the parameter's impact on the given application behavior(s) within the environment in question. Weight-based ranking unit 460 assigns a weight to each interaction of the parameters with the environment based on the interaction's impact on the application's behavior. Weight-based ranking unit 460 then compares the interaction of the parameters within the first environment with the interaction of the parameters within the second environment, and also compares the interaction of the parameters within the second environment with the interaction of the parameters within the third environment, and so on. For example, weight-based ranking unit 460 can compare the interaction of the parameters within the performance test environment with the interaction of the parameters within the production environment. The impact of interactions between multiple parameters within a given environment (e.g., the performance test environment) and within another environment (e.g., the production environment) can also be determined.

Weight-based ranking unit 460 can, for example, assign a magnitude value of weight based on the impact on a given application's application response time. A larger weight value is assigned to a first interaction (producing a larger impact on application response time) than a second interaction (producing a smaller impact on application response time). For example, the parameters can include configurations changes to a processor's configuration, the memory made available to the application, available network bandwidth, and storage parameters. Weight-based ranking unit 460 could assign, for example, a first weight to the processor's configuration, a second weight to memory space, a third weight to network bandwidth, and a fourth weight to available storage based on each parameter's impact on the application response time. Weight-based ranking unit 460 can assign a fifth weight to the interaction between processor parameters and memory parameters based on their interaction and a combined impact on the application response time. Weight-based ranking unit 460 can assign the a sixth weight to the interaction between the processor parameters and the number of threads allocated to the application's processes, based on the impact of such interactions on the application response time. The ranking interactions by interpreting weights component 406 ranks the interactions by interpreting the weights assigned to the interactions. Weight-based ranking unit 460 provides information to an interaction-based ranking unit 470.

Interaction-based ranking unit 470 ranks the weighted interactions based on the magnitudes of the weights produced by weight-based ranking unit 460. Interaction-based ranking unit 470 determines a strength for each weighted interaction. That being the case, a first weighted interaction having a larger magnitude than a second weighted interaction is assigned a higher order in the ranking. The strengths assigned to the interactions produced by interaction-based ranking unit 470 can be stored as statistical interaction information 430. Statistical interaction information 430 thus represents the nature of the interactions between the various application and environmental attributes, and their effects on application behavior in subsequent environments, from statistical perspective.

FIG. 5 is a simplified diagram illustrating an example of an interaction ranking system for ranking component interactions based on weighted interactions, in accordance with an embodiment of the present disclosure. FIG. 5 thus illustrates an interaction ranking system 500 including the ranking interactions by interpreting one or more weight components. The ranking of such interactions by interpreting weight components assigns weights to each of the attributes or parameters that impact the given application's behavior within an initial environment such as a development/functional test environment or performance test environment, and resulting application behavior in a subsequent environment such as a production environment, for example. The of ranking such interactions using weight components assigns weights to each interaction/combination of two or more attributes/parameters that may have a meaningful impact on the application's behavior (e.g., application response time) within the subsequent environment. For example, the attributes or parameters can be associated with the type of processor executing the application and/or environment, network performance, memory characteristics, and/or storage requirements. Such attributes or parameters can correspond to the system resources across the initial and subsequent environments. A ranking unit (e.g., interaction-based ranking unit 470 of FIG. 4) assigns a weight to each such factor within each of the environments. The ranking unit can assign a weight to an interaction between such factors, such as interactions between a processor's characteristics and network parameters, memory characteristics and storage characteristics, processor characteristics and memory characteristics, and/or other such combinations of system resources. Weights are assigned based on the impact of the given attribute(s), parameter(s), or combination thereof on the application behavior(s) within each of the environments. Through the use of the machine learning systems described herein, the ranking unit is able to rank such attributes, parameters, and their interactions based on the assigned weights. The weighted attributes, parameters, and interactions can be used to rank their impacts on application behavior. A magnitude value can be assigned to the weighted attributes, parameters, and interactions, and so the weighted attributes, parameters, and interactions can be ranked based on their magnitude values.

For example, as shown in FIG. 5, X₁ can represent the attribute, the parameter, or the interaction as an input to the ranking interactions by interpreting weights component 406, where I=1, 2, . . . P. In this example, X₁, X₂, . . . X_{P} are treated as interactions between combinations of system resource parameters, such as those related to the system's processor, memory, network, and/or storage. The variable Y can be treated as the impact upon the application response time, where Y=1, 2, . . . y. W⁽¹⁾, W⁽²⁾, . . . W^{y} are thus the weights assigned to the interactions according to their impact on the application response time. By assigning the weights to the attributes, parameters, and interactions, the configurations of or changes to the system resources within the heterogeneous environments (e.g., the initial and subsequent environments) can be used by the machine learning system to predict application response times. For example, the application response times can be effectively and efficiently predicted by ranking the higher-order interactions to provide the configurations or the changes to configurations that may allow the predicted application response time to meet requirements defined in a service level agreement (SLA).

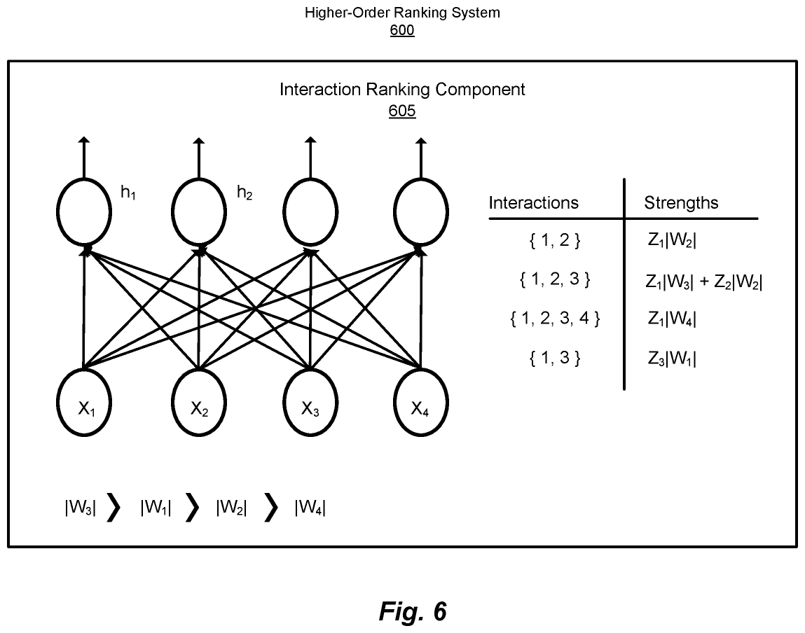

FIG. 6 is a simplified diagram illustrating an example of a higher-order ranking system for ranking attributes, parameters, and interactions based on their impacts on application behavior, in accordance with an embodiment of the present disclosure. FIG. 6 thus depicts a higher-order ranking system 600 that includes an interaction ranking component 650. Interaction ranking component 650 ranks the attributes, parameters, and interactions as higher-order interactions based on their strengths (their impacts on the application behaviors such as response time). The attributes, parameters and interactions are, in this example, treated as the inputs X₁, X₂, X₃, and X₄. For example, the X₁, X₂, X₃, and X₄ inputs can be factors such as processor characteristics, network characteristics, memory characteristics, and storage characteristics. W₂, W₁, W₂, W₃, and W₄, in this example, are the weights corresponding to the inputs X₁, X₂, X₃, and X₄. Z, in this example, is a factor applied to the inputs based on the type of the attribute or parameter. For example, a first factor can be applied to processor characteristics and a second factor can be applied to the memory's characteristics, and so on. Interaction ranking component 650 ranks the interactions of the inputs X₁, X₂, X₃, and X₄ higher-order interactions (such as h₁, h₂, . . . ) based on the strengths, such as the magnitude value of the impact on the application behavior such as response time.

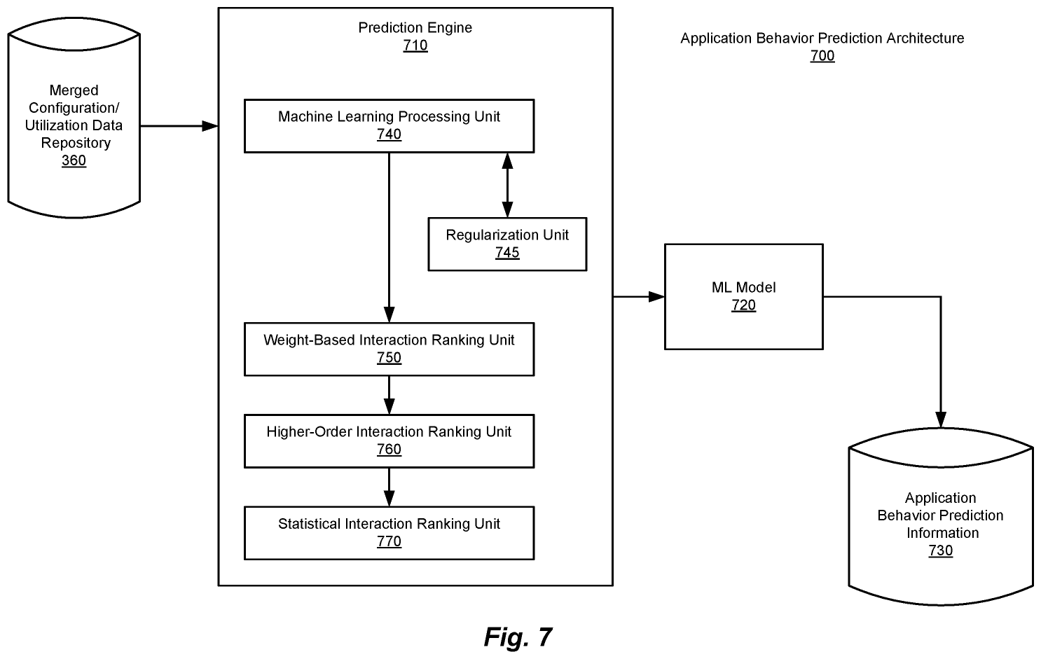

FIG. 7 is a simplified block diagram illustrating an example of an application behavior prediction architecture, in accordance with an embodiment of the present disclosure. FIG. 7 thus depicts an application behavior prediction architecture 700. As will be appreciated in light of the present disclosure and FIG. 7, application behavior prediction architecture 700 can be implemented, for example (and more specifically), as a multi-layer perceptron (MLP) machine learning architecture. Information from a merged configuration/utilization data repository (depicted in FIG. 7 as a merged configuration/utilization data repository 360, in the manner of that depicted in FIG. 3) provides merged configuration/utilization data to a prediction engine 710. In turn, prediction engine 710 communicates information to a machine learning (ML) model 720 (e.g., an MLP model). Results from the processing of such information produced using ML model 720 can then be stored as application behavior prediction information in an application behavior prediction information repository 730.

In order to produce the requisite information for ingestion by ML model 720, prediction engine 710 includes a machine learning processing unit 740, which can be implemented, for example, as a multi-layer perceptron (MLP) processing unit. Machine learning processing unit 740 is coupled to communicate with a regularization unit 745. Regularization unit 745, in certain embodiments, implements a process of adding information to that received by machine learning processing unit 740, in order to address problems with insufficiently defined information (in prediction engine 710, for example, a lack of certain measurements, parameters with excessive variability, and the like) and/or to prevent overfitting (the production of an analysis that corresponds too closely or exactly to a particular set of data, and may therefore fail to fit additional data or predict future observations reliably; in prediction engine 710, for example, scenarios in which machine learning model 720 would otherwise be tied too closely to a given environmental factor such that the model's overdependence on that factor would result in an unacceptably high sensitivity to changes in that factor, as between environments). For example, an MLP network with large network weights can be a sign of an unstable network, where small changes in the input can lead to large changes in the output. This can be a sign that the network has “over fit” the training dataset, and so is more likely perform poorly when making predictions on new data. A solution to this problem is to update the learning algorithm to encourage the network to keep the weights small. This is called weight regularization and it can be used as a general technique to reduce overfitting of the training dataset and improve the generalization of the model.

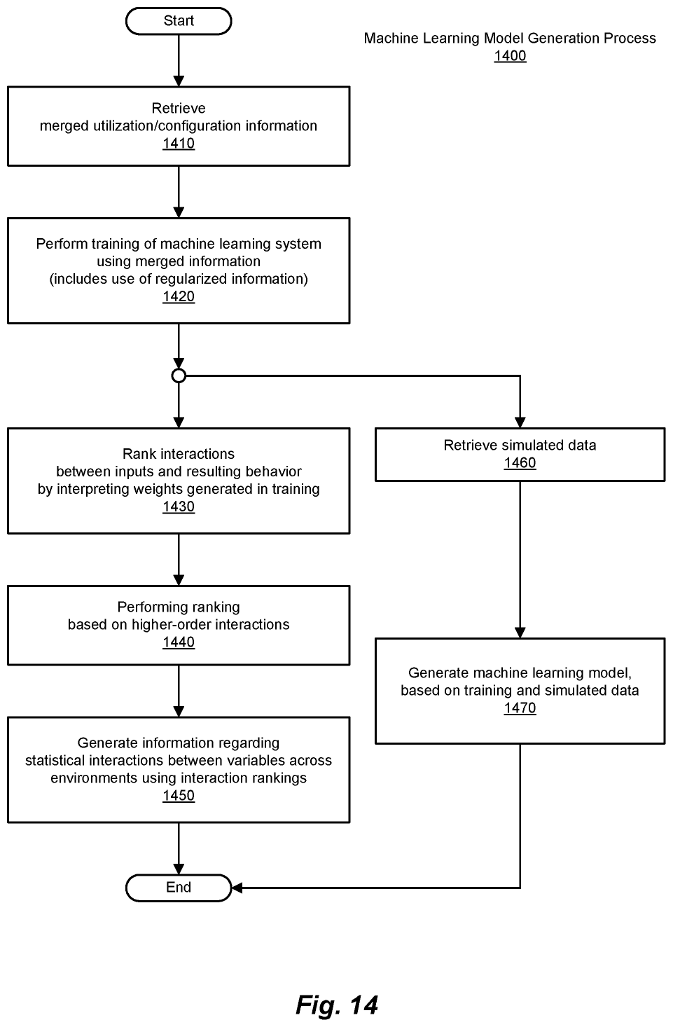

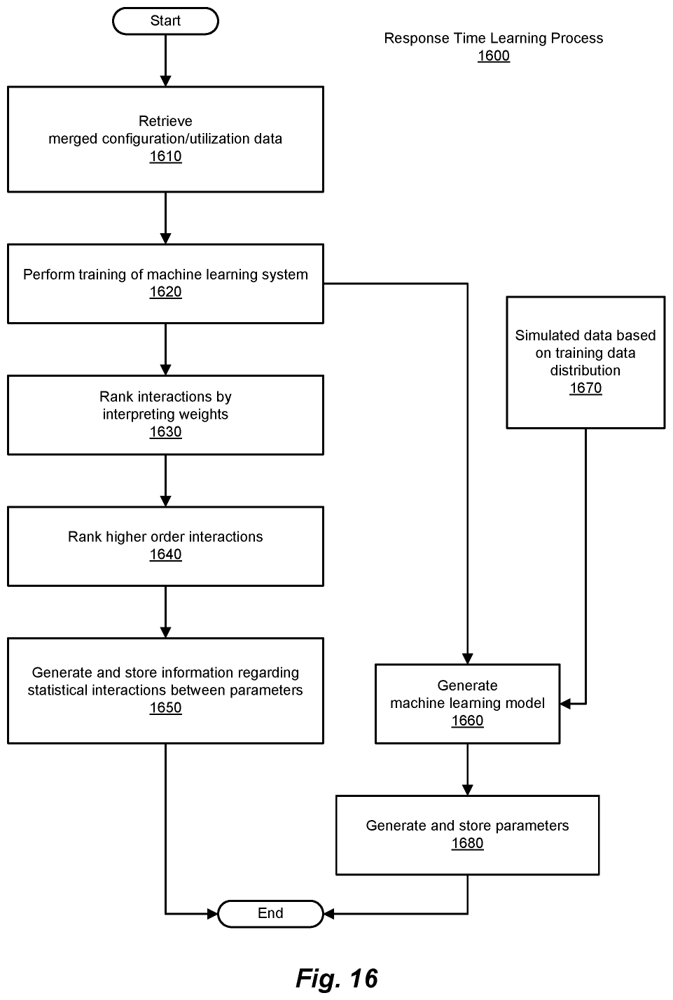

In support of the generation of ML model 720, ML processing unit 740 also produces information that is communicated to a weight-based interaction ranking unit 750. Weight-based interaction ranking unit 750 generates weight-based interaction ranking information, that is, in turn, provided to a higher-order interaction ranking unit 760. In turn, having generated higher-order interaction ranking information, higher-order interaction ranking unit 760 communicates such information to a statistical interaction ranking unit 770. These operations are discussed further in connection with the examples depicted in FIGS. 14 and 16, subsequently.

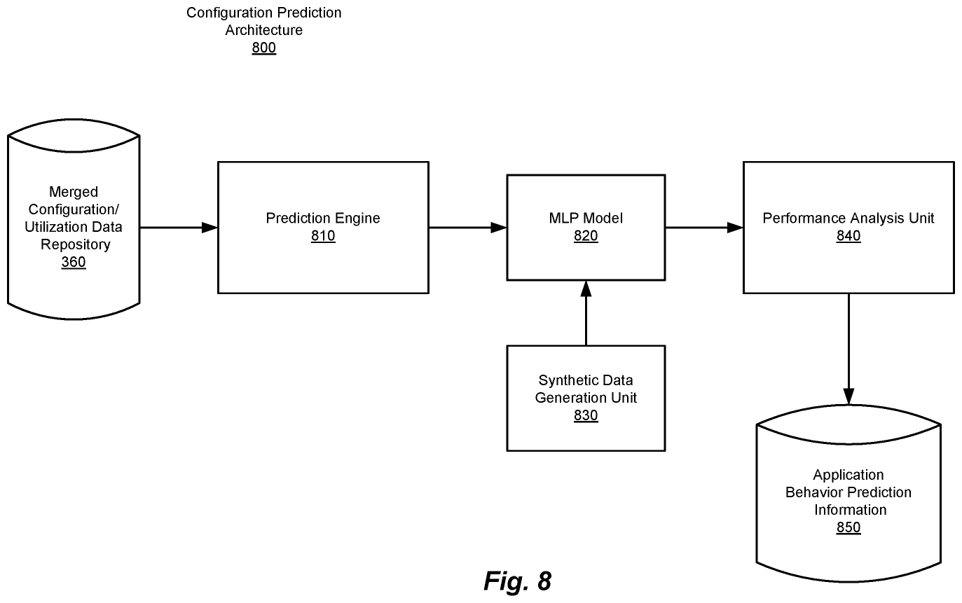

FIG. 8 is a simplified block diagram illustrating an example of a configuration prediction architecture, in accordance with an embodiment of the present disclosure. FIG. 8 thus depicts the configuration prediction architecture 800. Configuration prediction architecture 800, in the manner noted earlier, uses merged configuration/utilization data from, for example, a merged configuration/utilization data repository 360, such as that discussed earlier herein. Merged configuration/utilization data is provided to (or retrieved by) a prediction engine 810. Prediction engine 810 uses the merged configuration/utilization data from merged configuration/utilization data repository 360 as input to a multi-layer perceptron (MLP) model 820, which also receives synthetic data from a synthetic data generation unit 830. MLP model 820 provides results to a performance analysis unit 840, based on results generated by MLP model 820 using inputs from prediction engine 810 and synthetic data from synthetic data generation unit 830. Performance analysis unit 840 then stores results, produced from analyzing the information generated via MLP model 820, as application behavior prediction information in an application behavior prediction information repository 850.

### Examples of Machine Learning and Prediction Processes

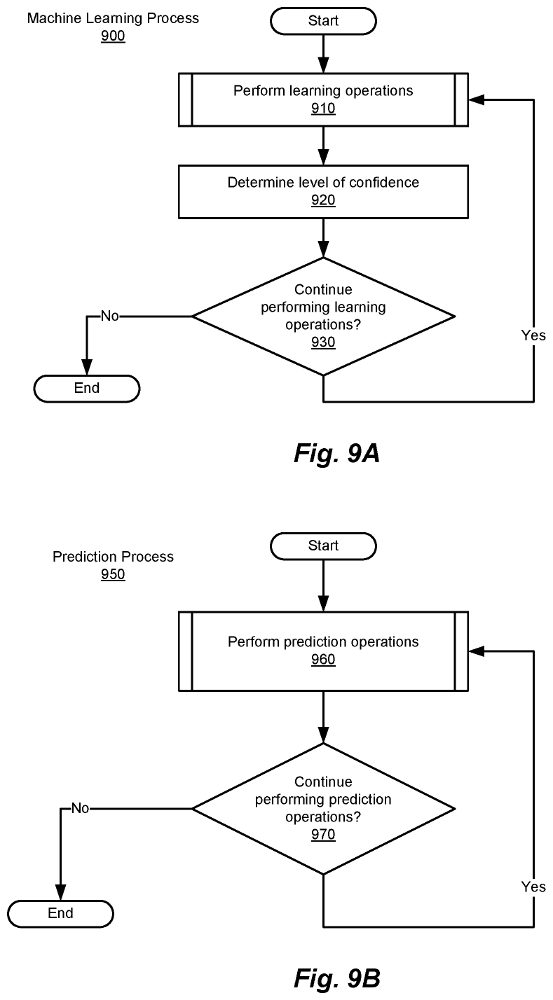

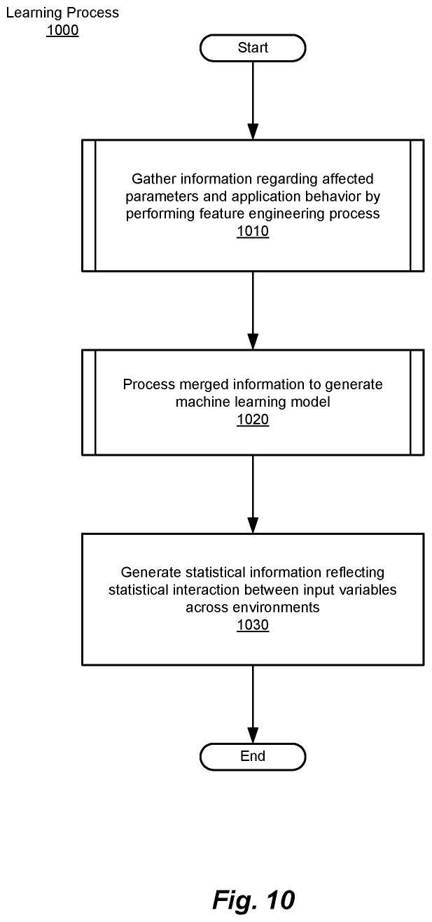

FIG. 9A is a simplified flow diagram illustrating an example of a machine learning process, in accordance with an embodiment of the present disclosure. FIG. 9A thus depicts a machine learning process 900. Machine learning process 900, as is depicted in FIG. 9A, illustrates an example of performing a number of iterations sufficient to provide a requisite level of confidence in the output of the machine learning system in question. That being the case, machine learning process 900 performs one or more learning operations (910). An example of the processes and operations effected in performing such learning operations are described in greater detail in connection with FIG. 10, subsequently. A determination is made as to a current level of confidence in the results produced by the machine learning system in comparison with, for example, a desired level of confidence (e.g., a threshold, confidence interval, or other such analysis) (920). A decision is then made as to whether learning operations by the machine learning system should be continued, in which case, machine learning process 900 loops in order to perform further learning operations (930). In the alternative (and in which case, a sufficient level of confidence has been achieved as to the accuracy of the machine learning system's output), machine learning process 900 concludes.

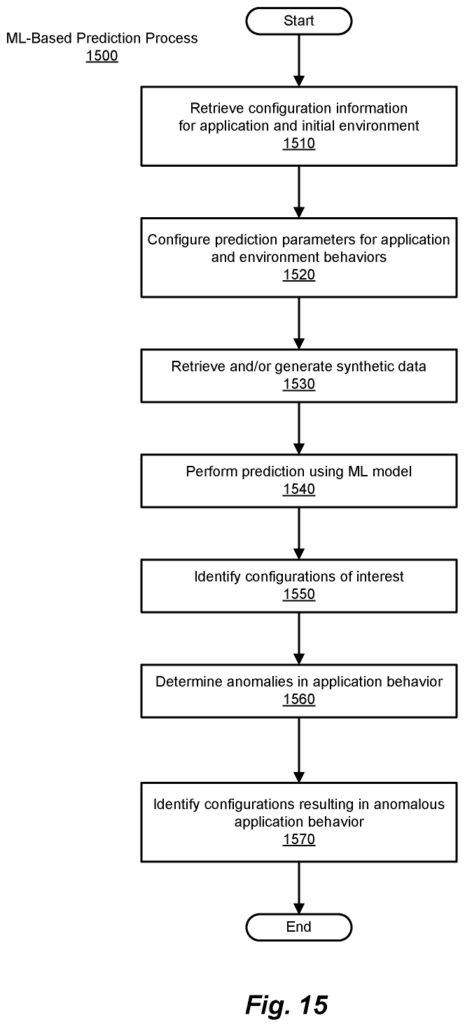

FIG. 9B is a simplified flow diagram illustrating an example of a prediction process, in accordance with an embodiment of the present disclosure. FIG. 9B thus depicts a prediction process 950. As before (in connection with FIG. 9A), prediction process 950 illustrates an example of performing a number of iterations sufficient to provide the information needed for the desired prediction(s) by the machine learning system. In the case of prediction process 950, then, one or more prediction operations are performed. An example of the processes and operations effected in performing such prediction operations are described in greater detail in connection with FIG. 15, subsequently. Such prediction operations can be continued (970), until such time as the desired amount and/or types of prediction information have been generated. Once the requisite prediction information has been generated, prediction process 950 concludes.

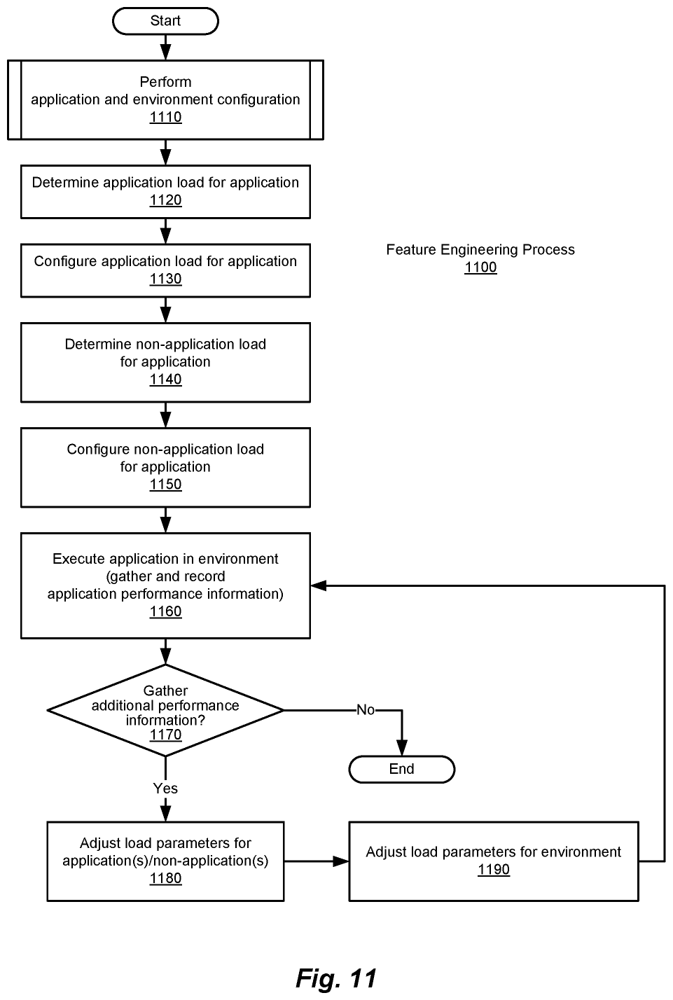

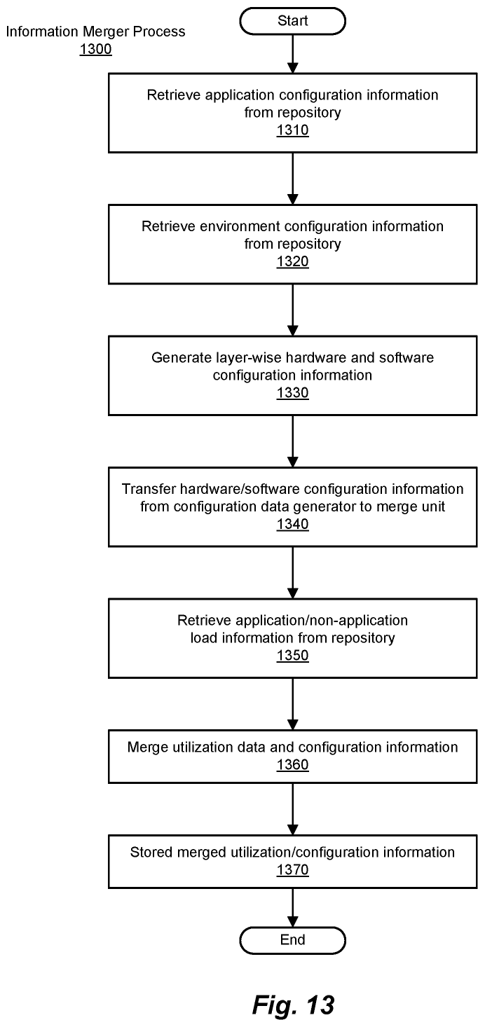

FIG. 10 is a simplified flow diagram illustrating an example of a learning process, in accordance with an embodiment of the present disclosure. FIG. 10 thus depicts a learning process 1000. Learning process 1000 begins with a process of gathering information regarding affected parameters and application behavior by performing a feature engineering process (1010). An example of the processes and operations effected in performing such a feature engineering process are described in greater detail in connection with FIG. 11, subsequently. Learning process 1000 then proceeds with the processing of merged information, in order to generate a machine learning model (1020). An example of the processes and operations effected in performing such an information merging process are described in greater detail in connection with FIG. 13, subsequently. The generated information having been merged, learning process 1000 proceeds to the generation of statistical information that reflects one or more statistical interactions between input variables, as may occur across environments, for example (1030). Learning process 1000 then concludes.

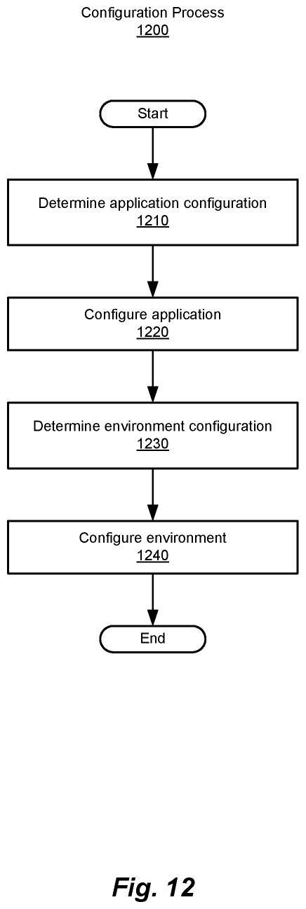

FIG. 11 is a simplified flow diagram illustrating an example of a feature engineering process, in accordance with an embodiment of the present disclosure. As noted in the discussion of learning process 1000 of FIG. 10, FIG. 11 depicts a feature engineering process 1100 that includes the gathering of information regarding affected parameters, as well as information regarding application behavior. Feature engineering process 1100 thus begins with operations related to the configuration of the application in question and the configuration of its environment, as well as, potentially, other applications, non-application loads, and other processes and systems that may have effects needing to be taken into consideration. An example of the processes and operations effected in performing such application and environment configuration processes are described in greater detail in connection with FIG. 12, subsequently.

The given application and environment having been configured (as well as, potentially, other loads, related or otherwise), and application load for the application in question is determined (1120). The application load thus determined for the application is then configured (1130). In a similar fashion, one or more non-application loads are determined (1140), and such non-application loads are configured (1150). The given application is then executed in the environment, and application performance information is gathered and recorded (1160). A determination is then made as to whether additional performance information is to be gathered (1170). If additional performance information is to be gathered, load parameters for the application in question, other applications, non-application loads, and other factors can be adjusted, in support of further learning (1180). Similarly, load (and/or other) environmental parameters can be adjusted, to similar effect (1190). Feature engineering process 1100 then iterates to the execution of the given application in the current environment, and application performance information is gathered and recorded (1160). Iteration in this manner can continue, until such time as no further additional performance information need be gathered (1170). At this juncture, feature engineering process 1100 concludes.

FIG. 12 is a simplified flow diagram illustrating an example of a configuration process, in accordance with an embodiment of the present disclosure. As noted in the discussion of feature engineering process 1100 of FIG. 11, FIG. 12 depicts a configuration process 1200. Configuration process 1200 begins with a determination as to the configuration of the application to be executed (1210). As will be appreciated in light of the present disclosure, a determination as to an application's configuration can include determining one or more operational behaviors of the application, desired resource requirements (e.g., including but not limited to storage resource requirements, computational resource requirements, network bandwidth requirements, and other such characteristics), operating characteristics (e.g., the configuration of tuning parameters, such as the number of buffers employed, the number of virtual machines used, and other such characteristics), and the like. Such application configuration parameters and constraints having been determined, configuration process 1200 configures the application in question according such parameters (1220). In comparable fashion, a determination is made as to the configuration of the environment in which the application is to execute (1230). As with the application to be executed, such a determination can include determination of various environmental variables, operating system parameters, execution priority, and other such characteristics and/or constraints. Such characteristics and/or constraints having been determined, configuration process 1200 then configures the environment (1240). Configuration process 1200 then concludes.

FIG. 13 is a simplified flow diagram illustrating an example of an information merger process, in accordance with an embodiment of the present disclosure. FIG. 13 thus depicts an information merger process 1300 that provides for the merging of application and environment configuration information, as well as load information, in order to produce a merged representation of such information. Information merger process 1300 begins with the retrieval of application configuration information (1310). Such application configuration information can be retrieved, for example, from an application configuration information repository such as application configuration information repository 310 of feature engineering architecture 300 in FIG. 3. Similarly, environment configuration information is retrieved (1320). Such environment configuration information can be retrieved, for example, from an environment configuration information repository such as environment configuration information repository 320 of feature engineering architecture 300 in FIG. 3. Next, in certain embodiments, layer-wise hardware and software configuration information is generated (1330). Such layer-wise hardware and software configuration information can be generated, for example, from the application and environment configuration information retrieved, for various layers of software (e.g., operating system layers, storage software layers, application and other programmatic layers, virtualization layers, network protocol layers, and the like) and hardware (e.g., local hardware computing resource layers, local and remote storage hardware layers, networking hardware layers, and the like). Such hardware/software configuration information can be generated, for example, by a configuration data generator such as configuration data generator 352 of FIG. 3. The hardware/software configuration information is then transferred from the configuration data generator to a utilization and configuration data merge unit such as utilization and configuration data merge unit 354 of FIG. 3 (1340). In certain embodiments, the utilization and configuration data merge unit also retrieves application/non-application load information (e.g., from an application and non-application load information repository such as application and non-application load information repository 330 of FIG. 3) (1350). Utilization data and configuration information such as that described can then be merged by the utilization and configuration data merge unit (1360). The merged utilization data and configuration information is then stored in a repository such as merged configuration/utilization data repository 360 of FIG. 3 (1370). Information merger process 1300 then concludes.

FIG. 14 is a simplified flow diagram illustrating an example of a machine learning model generation process, in accordance with an embodiment of the present disclosure. FIG. 14 thus depicts a machine learning model generation process 1400. Machine learning model generation process 1400 begins with the retrieval of merged utilization/configuration information (1410). Using the merged utilization/configuration information retrieved, machine learning model generation process 1400 performs training of the machine learning system using the merged information (1420). The machine learning system training performed at 1420 can include, in some embodiments, the use of regularization information, in the manner noted elsewhere herein.

Next, in one embodiment, machine learning model generation process 1400 performs two sets of operations. As will be appreciated in light of the present disclosure, the two sets of operations depicted in FIG. 14, while shown as being performed contemporaneously, can, in the alternative, be performed in a serial fashion, with either set of operations being performed before, after, or intermingled with the other. As depicted in FIG. 14, one set of such operations includes the ranking of interactions between inputs and their resulting behavior through the interpretation of weights generated during training (1430). Next, ranking based on higher-order interactions is performed (1440). Information regarding statistical interactions between such variables and the application behavior(s) produced thereby, across environments, is generated using the aforementioned interaction rankings (1450).

The second set of operations depicted in FIG. 14 begins with the retrieval of simulated data (1460). Such simulated data, as noted earlier herein, can be created by an SME in order to allow for constraints to be placed on the operation of the application and/or the environments involved, and so the machine learning model generated. A machine learning model can then be generated based on information determined during training and the simulated data retrieved, in the manner discussed in connection with FIG. 4 (1470). Machine learning model generation process 1400 then concludes.

FIG. 15 is a simplified flow diagram illustrating an example of a response time learning process, in accordance with an embodiment of the present disclosure. FIG. 15 thus depicts a machine learning-based (ML-based) prediction process 1500 (or more simply, prediction process 1500). As will be appreciated in the presence of the present disclosure, ML-based prediction process 1500 uses a machine learning model such as that generated by processes operations such as those described earlier herein. Prediction process 1500 begins with the retrieval of configuration information for the application in question, and, optionally, configuration information for the initial environment (1510). Prediction parameters for the application and environment behaviors (the latter of which can include the configuration of both the initial environment and the subsequent environment) are then configured (1520). Synthetic data is retrieved and/or generated for use as input to the machine learning system (1530). Such synthetic data can include data, parameter values, constraints, and other such information as may be created by a subject matter expert (SME), and/or such factors generated in an automated fashion (potentially under the control of an SME; such as one or more value ranges of environmental parameters, representing a number of operational scenarios). A machine learning processing unit (e.g., ML processing unit 740 of FIG. 7) receives the aforementioned configuration information and synthetic data in order to produce predicted application behavior information (1540).

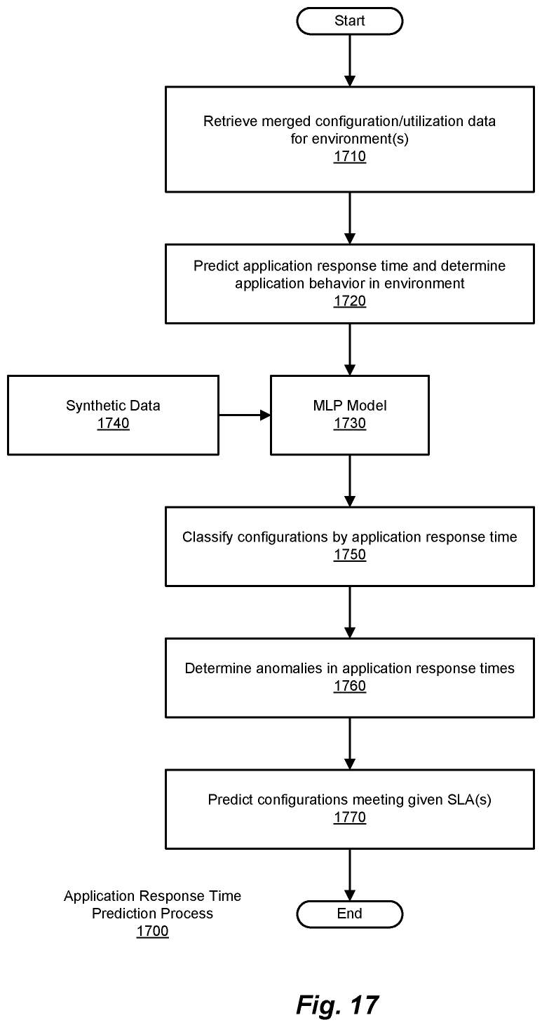

Having generated such predicted application behavior information, prediction process 1500 is then able to identify configurations of interest based on such behavior information (1550). Such might be the case, for example, with regard to application response times. Example processes with regard to application response times as between an initial environment and a subsequent environment are discussed in connection with FIGS. 16 and 17, subsequently. Configurations and other factors (including those of the application in question, the initial environment, the subsequent environment, and/or application/non-application loads, among other such factors) and the application behavior(s) resulting there from having been identified, a determination can be made as to any anomalies in such resulting application behavior(s) that are deemed to be of further interest (1560). Such might be the case, for example, with regard to the aforementioned response times, such determination being made based on a response time threshold, beyond which predicted application behavior information is to be further scrutinized. In turn, application/environment configurations resulting in such anomalous application behavior can be identified (1570). ML-based prediction process 1500 then concludes.

FIG. 16 is a simplified flow diagram illustrating an example of a response time learning process, in accordance with an embodiment of the present disclosure. FIG. 16 thus depicts a response time learning process 1600. Response time learning process 1600 begins with the prediction engine retrieving merged configuration/utilization data from a merged configuration/utilization data repository (1610). Such merged configuration/utilization data can include parameters impacting the application response time within the heterogeneous sets of environments, such as application configuration parameters, application environment configuration parameters, and application load and non-application load parameters. Such parameters can be associated, for example, with a development/functional test environment, a performance test environment, and/or a production environment. Such information facilitates the prediction engine's predictions as to application behavior (e.g., response times), and determines the effects of various factors thereon, as between environments. Response time learning process 1600 begins with the retrieval of merged configuration/utilization data from, for example, a merged configuration/utilization data repository such as merged configuration/utilization data repository 360 of FIG. 7 (1610).

Having retrieved the requisite information, training of the machine learning system employed can be performed (1620). For example, such training can be effected by the training of a multi-layer perceptron network (which in certain embodiments, includes regularization in order to improve the accuracy of predictions made by such a multi-layer perceptron network). The machine learning system determines the impact of each parameter on the application response time/behavior within the heterogeneous environments. The parameters are mapped as sets to corresponding output sets. The machine learning system performs operations that effect training (machine learning) of the system, where mapping the output sets is dynamic and automatic (and so without the need for SME interaction). The machine learning system also determines the impacts on application response times associated with each parameter and determines the impacts on the application response times associated with the interactions between two or more such parameters. The prediction engine sends the output sets and the interactions to the ranking interactions by interpreting weights component.

Next, interactions between parameters are ranked by interpreting weights assigned to such interactions (1630). In so doing, a weight-based interaction ranking unit, such as weight-based interaction ranking unit 750 of FIG. 7, assigns a weight to one or more parameters (or each parameter) within the environment. The assigned weight can be based, for example, on the parameter's impact on the application response time within the environment. The weight-based interaction ranking unit can also assign a weight to each interaction. Such assigned weights can be based on the interaction's impact on the application response time within the environment. The weight-based interaction ranking unit compares the assigned weights based on their magnitude values. The prediction engine sends the weighted parameters and the weighted interactions to a higher-order interaction ranking unit, such as higher-order interaction ranking unit 760 of FIG. 7.

Higher-order interactions are then ranked (1640). The ranking of higher-order interactions can be performed, as noted, by a higher-order interaction ranking unit, which ranks the weighted interactions based on the magnitudes of the weights. The higher-order interaction ranking unit determines a strength for each weighted interaction. The first weighted interaction can have a first magnitude (e.g., of strength) and the second interaction can have a second magnitude, in which case, the first magnitude might be greater than the second magnitude, for example. The ranking higher-order interactions component can also rank the weighted parameters based on the magnitudes of the weights. The strengths assigned to the interactions can be stored as variables in a statistical interactions database such as the statistical interaction information database shown in FIG. 4 as statistical interaction information 430. Thus, information regarding statistical interactions between such parameters is generated and stored (1650). At this juncture, in certain embodiments, the prediction engine can cause such information (the magnitude of strengths) to be stored as statistical interactions data in the statistical interactions database.

Information from the training of the machine learning system (1620) also leads to the generation of a machine learning model, such as a multi-layer perceptron model (1660). As part of the generation of the machine learning model, the machine learning system can ingest simulated data based on training data distribution, as well as other information, for example (1670). Thus, the prediction engine enables the machine learning model to generate the requisite model (e.g., an MLP model). In certain embodiments, the MLP model is also based on simulated data. Such simulated data can include constraints, such as a fixed value for the application response time (e.g., a desired application response time of three seconds). The MLP model can also take into consideration statistical interactions data. The prediction engine accounts for changes to the application configuration parameters (potentially as defined by the simulated data), the application environment configuration parameters, and the application load and the non-application load parameters that yield the given application behavior (e.g., application response time). In certain embodiments, such simulated data is based on the distributed data obtained from training the prediction engine in the prediction of application response times.

Parameters (as well as other information, depending on the implementation) are then generated and stored (1680). The prediction engine sends the information generated (and so associated with the machine learning model (e.g., parameters)) to be stored in a predicted response time database. As will be appreciated in light of the present disclosure, accurate prediction of application response times can include not only the effects of factors such as those described herein on application behavior, but also comprehends changes to such factors resulting from application behaviors. Response time learning process 1600 then concludes.

FIG. 17 is a simplified flow diagram illustrating an example of a response time prediction process, in accordance with an embodiment of the present disclosure. FIG. 17 thus depicts a response time prediction process 1700. Response time prediction process 1700 begins with the prediction engine's retrieval of merged configuration/utilization data from a merged configuration and utilization data repository (1710). Application response times and application behavior in the given environment is then predicted by the prediction engine (1720). In certain embodiments, the MLP model generates information regarding resulting application behavior based on the mapped output sets and the simulated data mentioned earlier herein. The mapped output sets are obtained as a result of the training, performed with the machine learning training unit, to generate the MLP model. The mapped output sets are obtained dynamically and automatically (and so without the need for SME interaction). In this regard, the simulated data can be retrieved from a database in which such simulated data is stored.

As part of this process, the prediction engine invokes, in the given embodiment, an MLP model (1730). The MLP model can also take as input synthetic data, which can be retrieved from existing information or generated on an as-needed basis. Such information can be provided by, for example, an SME, and can include information such as constraints, ranges of variables (e.g., in order to allow various scenarios to be tested and predicted), and the like. For example, the prediction engine can define the set of distributed data or the set of values for the configurations of the parameters to determine the predicted application response times. In certain embodiments, the SME can manually set parameters to constrain application behavior, such as setting a limit on application response time to a value of three seconds. Application behavior might be constrained in this manner, for example, in an effort to ensure that such application behavior meets or exceeds requirements set out in a service level agreement (SLA). The SME can cause the prediction engine to generate a series of predictions based on various configurations of the parameters to achieve the predetermined application response time.

Once the requisite predicted application response times have been generated, the prediction engine can classify the predicted application response times, for example, by the configurations that led to those response times (1750). Anomalous predicted application response times can then be identified (1760). In the present example, such anomalies might be identified by determining whether a given predicted application response time exceeded a threshold set, for example, in a service level agreement (SLA). Thus, the prediction engine predicts principal configurations that meet the application response time requirement (the threshold noted above) defined in the applicable SLAs. For example, the prediction engine can predict that a configuration of the parameters requires a change in the amount of memory allocated to the application in question. The amount of memory allocated thusly may be a fixed parameter that is unable to be changed. The prediction engine thus determines the primary configurations that yield application behavior meeting the given SLA(s), based on changes to the configurations of the parameters that include such a fixed amount of memory.

Having identified such anomalous predicted application response times, the prediction engine can then identify configurations from the remaining predicted application response times, and in so doing, identify configurations that allow the application in question to meet the given SLA (1770). Application response time prediction process 1700 then concludes.

### An Example Computing and Network Environment

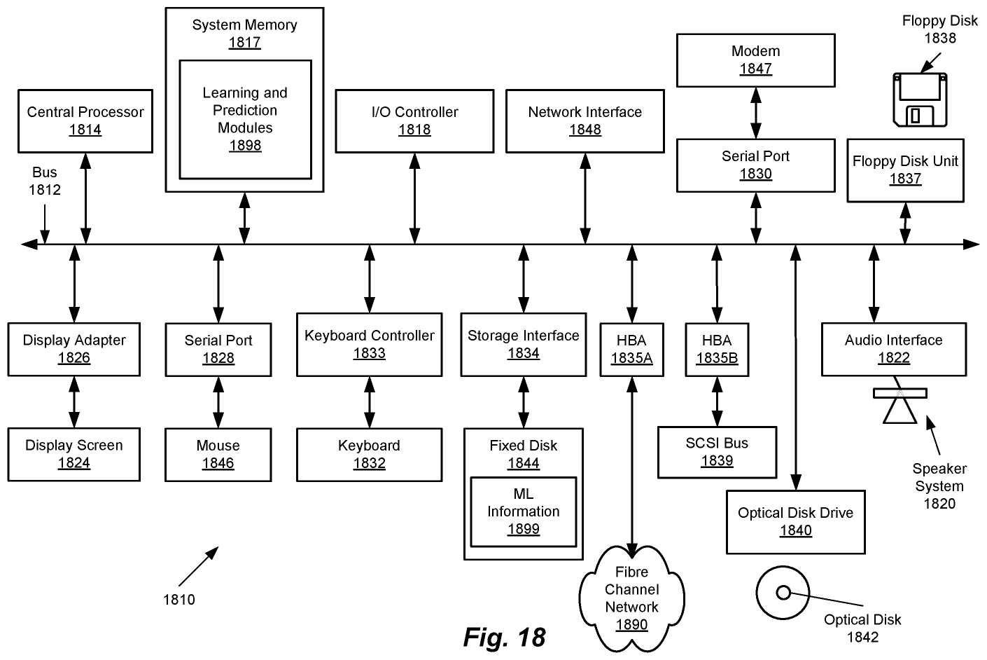

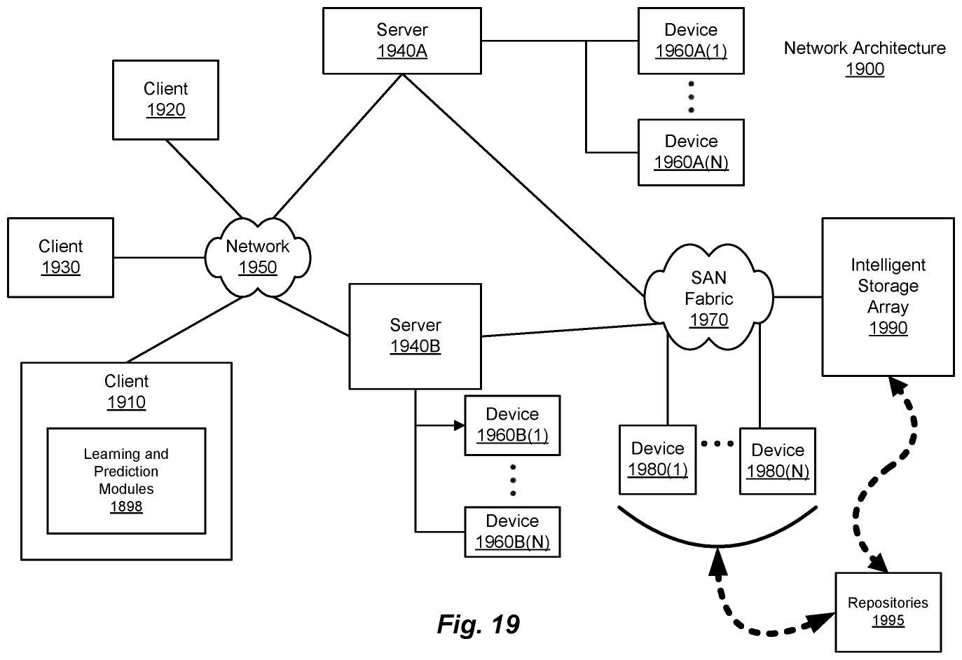

As shown above, the present invention can be implemented using a variety of computer systems and networks. An example of one such computing and network environment is described below with reference to FIGS. 18 and 19.

FIG. 18 depicts a block diagram of a computer system 1810 suitable for implementing aspects of the present invention (e.g., servers 620, gateway server 650, clients 660 and web clients 665). Computer system 1810 includes a bus 1812 which interconnects major subsystems of computer system 1810, such as a central processor 1814, a system memory 1817 (typically RAM, but which may also include ROM, flash RAM, or the like), an input/output controller 1818, an external audio device, such as a speaker system 1820 via an audio output interface 1822, an external device, such as a display screen 1824 via display adapter 1826, serial ports 1828 and 1830, a keyboard 1832 (interfaced with a keyboard controller 1833), a storage interface 1834, a floppy disk drive 1837 operative to receive a floppy disk 1838, a host bus adapter (HBA) interface card 1835A operative to connect with a Fibre Channel network 1890, a host bus adapter (HBA) interface card 1835B operative to connect to a SCSI bus 1839, and an optical disk drive 1840 operative to receive an optical disk 1842. Also included are a mouse 1846 (or other point-and-click device, coupled to bus 1812 via serial port 1828), a modem 1847 (coupled to bus 1812 via serial port 1830), and a network interface 1848 (coupled directly to bus 1812).

Bus 1812 allows data communication between central processor 1814 and system memory 1817, which may include read-only memory (ROM) or flash memory (neither shown), and random access memory (RAM) (not shown), as previously noted. The RAM is generally the main memory into which the operating system and application programs are loaded. The ROM or flash memory can contain, among other code, the Basic Input-Output system (BIOS) which controls basic hardware operation such as the interaction with peripheral components. Applications resident with computer system 1810 are generally stored on and accessed via a computer-readable medium, such as a hard disk drive (e.g., fixed disk 1844), an optical drive (e.g., optical drive 1840), a floppy disk unit 1837, or other computer-readable storage medium.

Storage interface 1834, as with the other storage interfaces of computer system 1810, can connect to a standard computer-readable medium for storage and/or retrieval of information, such as a fixed disk drive 1844. Fixed disk drive 1844 may be a part of computer system 1810 or may be separate and accessed through other interface systems. Modem 1847 may provide a direct connection to a remote server via a telephone link or to the Internet via an internet service provider (ISP). Network interface 1848 may provide a direct connection to a remote server via a direct network link to the Internet via a POP (point of presence). Network interface 1848 may provide such connection using wireless techniques, including digital cellular telephone connection, Cellular Digital Packet Data (CDPD) connection, digital satellite data connection or the like.

Also depicted in FIG. 18 are learning and prediction modules 1898 and machine learning information 1899. Learning and prediction modules 1898 are shown as being stored in system memory 1817, and as a result of such depiction, indicate their execution. Learning and prediction modules 1898 can include, when implemented as program instructions, modules providing the functionality of one or more of a machine learning processing unit, a regularization unit, a weight-based interaction ranking unit, a higher-order interaction ranking unit, a statistical interaction ranking unit, a machine learning model, and/or modules providing other functionality in support of the methods and systems described herein. Further, the depiction of learning and prediction modules 1898 serve merely as examples, and so are not to be interpreted as requiring any of these modules to be executed in conjunction with any other of these modules on the same computing device.

In a similar manner of depiction, machine learning information 1899 can include, for example, one or more of merged configuration/utilization data, application behavior prediction information, behavioral prediction information, statistical interaction information, application configuration information, environment configuration information, application load information, non-application load information, and/or other information in support of the methods and systems described herein. Further, the depiction of machine learning information 1899 serves merely as an example, and so is not to be interpreted as requiring any of such information to be stored in conjunction with any other such information.

Many other devices or subsystems (not shown) may be connected in a similar manner (e.g., document scanners, digital cameras and so on). Conversely, all of the devices shown in FIG. 18 need not be present to practice the present invention. The devices and subsystems can be interconnected in different ways from that shown in FIG. 18. The operation of a computer system such as that shown in FIG. 18 is readily known in the art and is not discussed in detail in this application. Code to implement the present invention can be stored in computer-readable storage media such as one or more of system memory 1817, fixed disk 1844, optical disk 1842, or floppy disk 1838. The operating system provided on computer system 1810 may be MS-DOS®, MS-WINDOWS®, UNIX®, Linux®, or another known operating system.

Moreover, regarding the signals described herein, those skilled in the art will recognize that a signal can be directly transmitted from a first block to a second block, or a signal can be modified (e.g., amplified, attenuated, delayed, latched, buffered, inverted, filtered, or otherwise modified) between the blocks. Although the signals of the above described embodiment are characterized as transmitted from one block to the next, other embodiments of the present invention may include modified signals in place of such directly transmitted signals as long as the informational and/or functional aspect of the signal is transmitted between blocks. To some extent, a signal input at a second block can be conceptualized as a second signal derived from a first signal output from a first block due to physical limitations of the circuitry involved (e.g., there will inevitably be some attenuation and delay). Therefore, as used herein, a second signal derived from a first signal includes the first signal or any modifications to the first signal, whether due to circuit limitations or due to passage through other circuit elements which do not change the informational and/or final functional aspect of the first signal.

FIG. 19 is a block diagram depicting a network architecture 1900 in which client systems 1910, 1920 and 1930, as well as storage servers 1940A and 1940B (any of which can be implemented using computer system 1910), are coupled to a network 1950. Storage server 1940A is further depicted as having storage devices 1960A(1)-(N) directly attached, and storage server 1940B is depicted with storage devices 1960B(1)-(N) directly attached. Storage servers 1940A and 1940B are also connected to a SAN fabric 1970, although connection to a storage area network is not required for operation of the invention. SAN fabric 1970 supports access to storage devices 1980(1)-(N) by storage servers 1940A and 1940B, and so by client systems 1110, 1120 and 1130 via network 1150. Intelligent storage array 1190 is also shown as an example of a specific storage device accessible via SAN fabric 1970.

Also depicted in FIG. 19 are learning and prediction modules 1898 and repositories 1995. Learning and prediction modules 1898 are the same as or similar to those shown depicted in FIG. 18, and the observations made with respect to learning and prediction modules 1898 in the discussion of FIG. 18 above apply to FIG. 19 as well. In a similar manner to machine learning information 1899, repositories 1995 can include, for example, one or more of a merged configuration/utilization data repository, and application behavior prediction information repository, a behavioral prediction information repository, a statistical interaction information repository, and application configuration information repository, and environment configuration information repository, and application load information repository, a non-application load information repository, and/or other repository in support of the methods and systems described herein. Further, the depiction of repositories 1995 serves merely as an example, and so is not to be interpreted as requiring any of such information to be stored in conjunction with any other such information.

With reference to computer system 1810, modem 1847, network interface 1848 or some other method can be used to provide connectivity from each of client computer systems 1910, 1920 and 1930 to network 1950. Client systems 1910, 1920 and 1930 are able to access information on storage server 1940A or 1940B using, for example, a web browser or other client software (not shown). Such a client allows client systems 1910, 1920 and 1930 to access data hosted by storage server 1940A or 1940B or one of storage devices 1960A(1)-(N), 1960B(1)-(N), 1980(1)-(N) or intelligent storage array 1990. FIG. 19 depicts the use of a network such as the Internet for exchanging data, but the present invention is not limited to the Internet or any particular network-based environment.

### Other Embodiments

The present invention is well adapted to attain the advantages mentioned as well as others inherent therein. While the present invention has been depicted, described, and is defined by reference to particular embodiments of the invention, such references do not imply a limitation on the invention, and no such limitation is to be inferred. The invention is capable of considerable modification, alteration, and equivalents in form and function, as will occur to those ordinarily skilled in the pertinent arts. The depicted and described embodiments are examples only, and are not exhaustive of the scope of the invention.

The foregoing describes embodiments including components contained within other components (e.g., the various elements shown as components of computer system 1810). Such architectures are merely examples, and, in fact, many other architectures can be implemented which achieve the same functionality. In an abstract but still definite sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermediate components. Likewise, any two components so associated can also be viewed as being “operably connected,” or “operably coupled,” to each other to achieve the desired functionality.

The foregoing detailed description has set forth various embodiments of the present invention via the use of block diagrams, flowcharts, and examples. It will be understood by those within the art that each block diagram component, flowchart step, operation and/or component illustrated by the use of examples can be implemented, individually and/or collectively, by a wide range of hardware, software, firmware, or any combination thereof.

The present invention has been described in the context of fully functional computer systems; however, those skilled in the art will appreciate that the present invention is capable of being distributed as a program product in a variety of forms, and that the present invention applies equally regardless of the particular type of computer-readable media used to actually carry out the distribution. Examples of computer-readable media include computer-readable storage media, as well as media storage and distribution systems developed in the future.

The above-discussed embodiments can be implemented by software modules that perform one or more tasks associated with the embodiments. The software modules discussed herein may include script, batch, or other executable files. The software modules may be stored on a machine-readable or computer-readable storage media such as magnetic floppy disks, hard disks, semiconductor memory (e.g., RAM, ROM, and flash-type media), optical discs (e.g., CD-ROMs, CD-Rs, and DVDs), or other types of memory modules. A storage device used for storing firmware or hardware modules in accordance with an embodiment of the invention can also include a semiconductor-based memory, which may be permanently, removably or remotely coupled to a microprocessor/memory system. Thus, the modules can be stored within a computer system memory to configure the computer system to perform the functions of the module. Other new and various types of computer-readable storage media may be used to store the modules discussed herein.

The above description is intended to be illustrative of the invention and should not be taken to be limiting. Other embodiments within the scope of the present invention are possible. Those skilled in the art will readily implement the steps necessary to provide the structures and the methods disclosed herein, and will understand that the process parameters and sequence of steps are given by way of example only and can be varied to achieve the desired structure as well as modifications that are within the scope of the invention. Variations and modifications of the embodiments disclosed herein can be made based on the description set forth herein, without departing from the scope of the invention.

Consequently, the invention is intended to be limited only by the scope of the appended claims, giving full cognizance to equivalents in all respects.

Although the invention has been described in connection with several embodiments, the invention is not intended to be limited to the specific forms set forth herein. On the contrary, it is intended to cover such alternatives, modifications, and equivalents as can be reasonably included within the scope of the invention as defined by the appended claims.

What is claimed is:

1. A method comprising:
retrieving merged configuration/utilization data, wherein
the merged configuration/utilization data comprises
at least a portion of application configuration information, and
at least a portion of environment configuration information,
the application configuration information is information regarding a configuration of an application, and
the environment configuration information is information regarding a configuration of an environment in which the application is executed; and
generating predicted application behavior information, wherein
the predicted application behavior information is generated using a machine learning model, and
the machine learning model receives the merged configuration/utilization data as one or more inputs.

2. The method of claim 1, further comprising:
identifying one or more configurations from a plurality of configurations, wherein
the one or more configurations are identified using the predicted application behavior information,
the application configuration information and the environment configuration information are for a first environment, and
the predicted application behavior information is generated with respect to a second environment.

3. The method of claim 2, further comprising:
identifying an anomalous application behavior of a plurality of application behaviors,
wherein
the anomalous application behavior is identified using the predicted application behavior information.

4. The method of claim 3, further comprising:
identifying an identified configuration, wherein
the one or more configurations comprise the identified configuration, and
the identified configuration is associated with the anomalous application behavior.

5. The method of claim 4, further comprising:
identifying another configuration, wherein
the another configuration is a configuration of the one or more configurations other than the identified configuration,
an application behavior is associated with the another configuration,
the plurality of application behaviors comprise the application behavior, and
the application behavior meets a requirement of a service level agreement.

6. The method of claim 1, wherein
the machine learning model is a multi-layer perceptron model.

7. The method of claim 1, further comprising:
retrieving merged information, wherein
the merged information comprises utilization information and configuration information;
generating training information by performing a training operation; and
generating a machine learning model, wherein
the machine learning model is generated based, at least in part, on the training information.

8. The method of claim 7, further comprising:
performing a first ranking operation on each of a plurality of parameters by assigning a weight of one or more weights to the each of the plurality of parameters, wherein the first ranking operation produces a weighted set of parameters; and
performing a second ranking operation on one or more interactions between the plurality of parameters by assigning one or more weights to each of the one or more interactions, wherein
the second ranking operation produces a weighted set of interactions.

9. The method of claim 8, further comprising:
performing a higher-order ranking operation, wherein
the higher-order ranking operation uses the weighted set of parameters and the weighted set of interactions; and
generating statistical information, wherein
the statistical information is generated based on a result of the higher-order ranking operation.

10. The method of claim 7, further comprising:
generating the merged information by merging the utilization information and the configuration information, wherein
the utilization information comprises application utilization information and environment utilization information, and
the configuration information comprises application configuration information and environment configuration information.

11. The method of claim 1, wherein
the merged configuration/utilization data further comprises
at least a portion of utilization information,
the utilization information is information regarding at least one of
at least a portion of application load information, or
at least a portion of non-application load information,
the application load information is information regarding one or more load parameters for an application, and
the non-application load information is information regarding one or more load parameters for one or more non-application loads.

12. A computer program product comprising:
a plurality of instructions, comprising
a first set of instructions, executable by a processor of a computer system, configured to retrieve merged configuration/utilization data, wherein
the merged configuration/utilization data comprises
at least a portion of application configuration information, and
at least a portion of environment configuration information,
the application configuration information is information regarding a configuration of an application, and
the environment configuration information is information regarding a configuration of an environment in which the application is executed,
a second set of instructions, executable by the processor, configured to generate predicted application behavior information, wherein
the predicted application behavior information is generated using a machine learning model, and
the machine learning model receives the merged configuration/utilization data as one or more inputs; and
a non-transitory computer-readable storage medium, wherein the plurality of instructions is encoded in the non-transitory computer-readable storage medium.

13. The computer program product of claim 12, wherein the instructions further comprise:
a third set of instructions, executable by the processor, configured to identify one or more configurations from a plurality of configurations, wherein
the one or more configurations are identified using the predicted application behavior information,
the application configuration information and the environment configuration information are for a first environment, and
the predicted application behavior information is generated with respect to a second environment.

14. The computer program product of claim 13, wherein the instructions further comprise:
a fourth set of instructions, executable by the processor, configured to identify an anomalous application behavior of a plurality of application behaviors, wherein the anomalous application behavior is identified using the predicted application behavior information.

15. The computer program product of claim 13, wherein the instructions further comprise:
a fourth set of instructions, executable by the processor, configured to retrieve merged information, wherein
the merged information comprises utilization information and configuration information;
a fifth set of instructions, executable by the processor, configured to generate training information by performing a training operation; and
a sixth set of instructions, executable by the processor, configured to generate a machine learning model, wherein
the machine learning model is generated based, at least in part, on the training information.

16. The computer program product of claim 15, wherein the instructions further comprise:
a seventh set of instructions, executable by the processor, configured to perform a first ranking operation on each of a plurality of parameters by assigning a weight of one or more weights to the each of the plurality of parameters, wherein the first ranking operation produces a weighted set of parameters;
a eighth set of instructions, executable by the processor, configured to perform a second ranking operation on one or more interactions between the plurality of parameters by assigning one or more weights to each of the one or more interactions, wherein the second ranking operation produces a weighted set of interactions;
a ninth set of instructions, executable by the processor, configured to perform a higher-order ranking operation, wherein
the higher-order ranking operation uses the weighted set of parameters and the weighted set of interactions; and
a tenth set of instructions, executable by the processor, configured to perform statistical information, wherein
the statistical information is generated based on a result of the higher-order ranking operation.

17. The computer program product of claim 12, wherein
the machine learning model is a multi-layer perceptron model,
the merged configuration/utilization data further comprises
at least a portion of utilization information,
the utilization information is information regarding at least one of
at least a portion of application load information, or
at least a portion of non-application load information,
the application load information is information regarding one or more load parameters for an application, and
the non-application load information is information regarding one or more load parameters for one or more non-application loads.

18. A computer system comprising:
one or more processors;
a computer-readable medium, coupled to the one or more processors; and
a plurality of computer program instructions, wherein
the plurality of computer program instructions is encoded in the computer-readable medium, and
the plurality of computer program instructions are executable by the one or more processors to
retrieve merged configuration/utilization data, wherein
the merged configuration/utilization data comprises
at least a portion of application configuration information, and
at least a portion of environment configuration information,
the application configuration information is information regarding a configuration of an application, and
the environment configuration information is information regarding a configuration of an environment in which the application is executed, and
generate predicted application behavior information, wherein
the predicted application behavior information is generated using a machine learning model, and
the machine learning model receives the merged configuration/utilization data as one or more inputs.

19. The computer system of claim 18, wherein the plurality of computer program instructions are further executable by the one or more processors to:
identify one or more configurations from a plurality of configurations, wherein
the one or more configurations are identified using the predicted application behavior information,
the application configuration information and the environment configuration information are for a first environment, and
the predicted application behavior information is generated with respect to a second environment.

20. The computer system of claim 18, wherein
the machine learning model is a multi-layer perceptron model,
the merged configuration/utilization data further comprises
at least a portion of utilization information,
the utilization information is information regarding at least one of
at least a portion of application load information, or
at least a portion of non-application load information,
the application load information is information regarding one or more load parameters for an application, and
the non-application load information is information regarding one or more load parameters for one or more non-application loads.
